(19) United States
(12) Patent Application Publication
(10) Pub. No.: US 2009/0135162 A1
(43) Pub. Date: May 28, 2009

(54) System and Method For Detecting the Location, Size and Shape of Multiple Objects That Interact With a Touch Screen Display

(75) Inventors: Sander B.F. Van De Wijdeven, Eindhoven (NL); Tatiana A. Lashina, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,032

(22) PCT Filed: Mar. 8, 2006
(86) PCT No.: PCT/IB2006/050728

§ 371 Date: Sep. 7, 2007

Related U.S. Application Data
(60) Provisional application No. 60/660,366, filed on Mar. 10, 2005.

(51) Int. Cl. G06F 3/042

(52) U.S. Cl. 345/175

(57) ABSTRACT

A system, method and apparatus is disclosed for detecting the location, size and shape of an object, or multiple objects, placed on a plane within the touch sensor boundaries of a touch screen (10).

The present invention relates generally to touch screen displays, and more particularly, to methods and apparatus for detecting the location, size and shape of multiple objects that interact with a touch screen display.

Touch screens are commonly used as pointing sensors to provide a man-machine interface for computer driven systems. Typically, for an optical touch screen, a number of infrared optical emitters (i.e., transmitters) and detectors (i.e., receivers) are arranged around the periphery of the display screen to create a plurality of intersecting light paths. When a user touches the display screen, the user's finger blocks the optical transmission of certain ones of the perpendicularly arranged transmitter/receiver pairs. Based on the identity of the blocked pairs, the touch screen system can determine the location of the intercept (single point interaction). With such a screen, a particular choice can be selected by a user by touching the area of the screen where that choice is displayed, which can be a menu option or a button. This use of perpendicular light beams, while widely used, is unable to effectively detect the shape and size of an object. Neither can the use of perpendicular light beams detect multiple objects or multiple touch points.

It would therefore be desirable for touch screen applications to be able to determine the shape and size of an object, in addition to being able to detect multiple touch points. These applications would also benefit from the ability to determine the transparency and reflectivity of the one or more objects.

The present invention provides methods and apparatus for detecting the location, size and shape of one or more objects placed on a plane within the touch sensor boundaries of a touch screen display. Methods are also provided for detecting an object's, or multiple objects', reflectivity and transparency.

According to an aspect of the present invention, an apparatus for detecting the location, size and shape of an object, or multiple objects, placed on a plane within the touch sensor boundaries of a touch screen, according to one embodiment, includes a plurality of light transmitters (N) and sensors (M) arranged in an alternating pattern on the periphery of the touch screen.

According to another aspect of the present invention, a method for detecting an object's, or multiple objects', location, size and shape, comprises the acts of: (a) acquiring calibration data for each of (N) light transmitters Lᵢ arranged around the periphery of a touch screen display; (b) acquiring non-calibration data for each of the (N) light transmitters Lᵢ; (c) computing N minimum area estimates of at least one object positioned in the plane of the touch screen display using the calibration data and the non-calibration data computed at acts (a) and (b); (d) combining the N minimum area estimates to derive a total minimum object area of the at least one object; (e) computing (N) maximum area estimates of the at least one object using the calibration data and the non-calibration data computed at acts (a) and (b); (f) combining the N maximum area estimates to derive a total maximum object area of the at least one object; and (g) combining the total minimum and maximum object areas to derive the boundary area of the at least one object.

According to one embodiment, the light transmitters and receivers can be located in separate parallel planes in close proximity. In such an embodiment, the density of light transmitters and receivers is substantially increased thus providing for increased resolution and precision in defining the location, shape and size of the at least one object.

According to one aspect, specific types of photo-sensors may be employed to provide a capability for detecting the reflectivity or conversely the transmissivity of certain objects thus providing additional information regarding the optical properties of the material constituting the object. For example, based on the detected differences in light transmission, reflection, absorption the touch screen can distinguish between a person's hand, a stylus or a pawn used in an electronic board game.

The foregoing features of the present invention will become more readily apparent and may be understood by referring to the following detailed description of an illustrative embodiment of the present invention, taken in conjunction with the accompanying drawings, where:

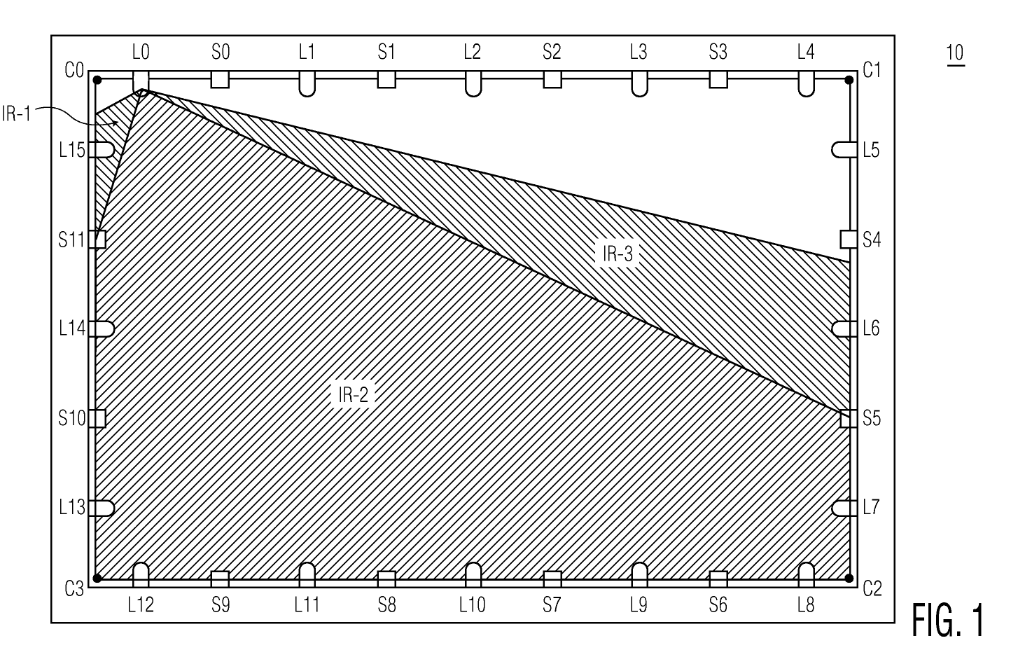

FIGS. 1 & 2 illustrate a snapshot of the touch screen display during a point in time at which the first and second light sources are switched on during a calibration mode;

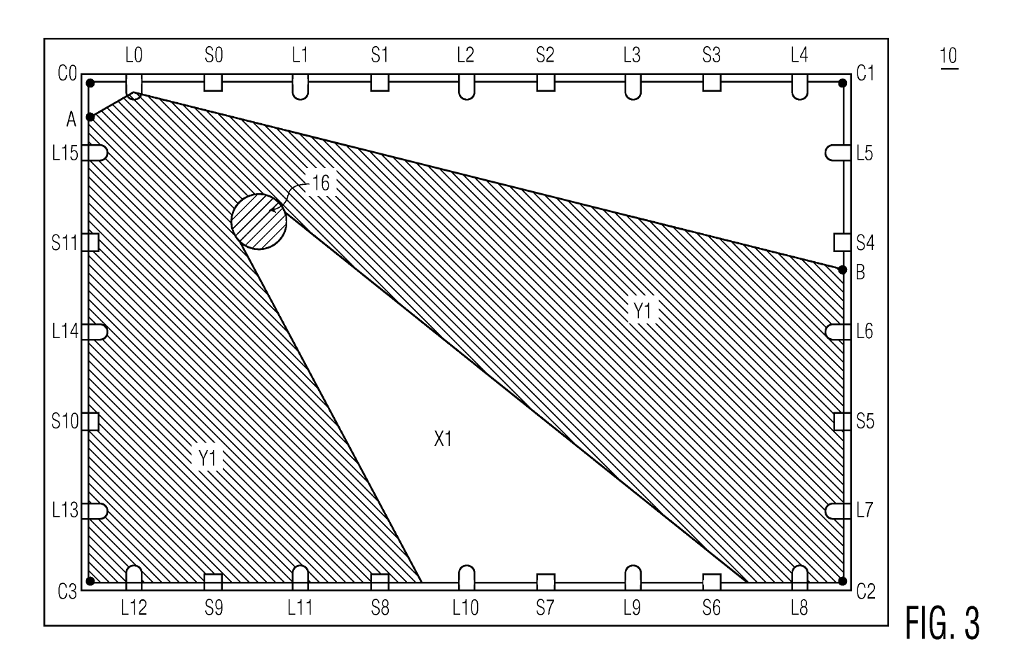

FIGS. 3 & 4 illustrate a snapshot of the touch screen display during a point in time at which the first and second light sources are switched on during an operational mode;

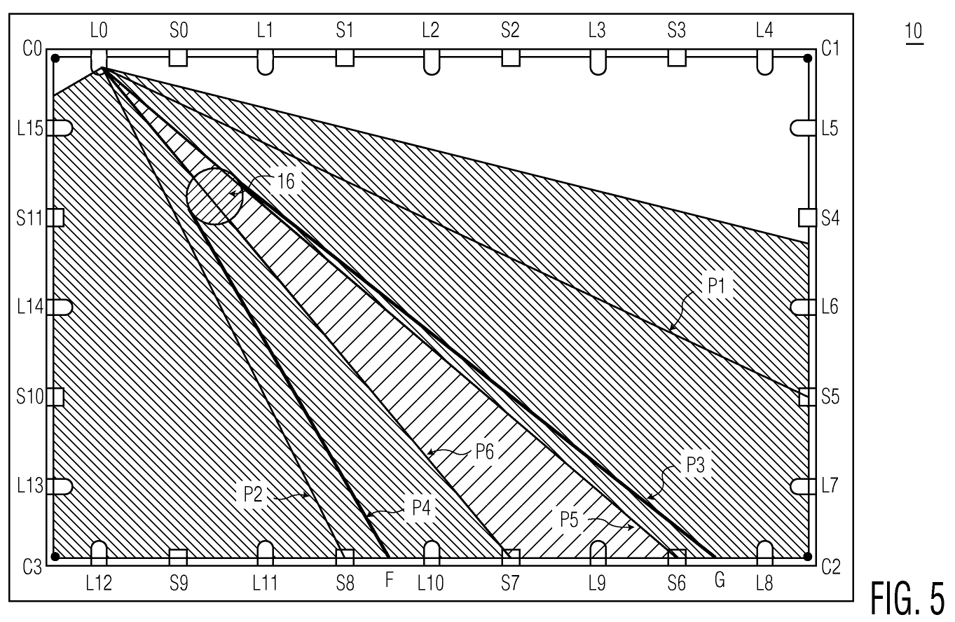

FIG. 5 illustrates a snapshot that shows how minimum and maximum area estimates are being made using the calibration and non-calibration data;

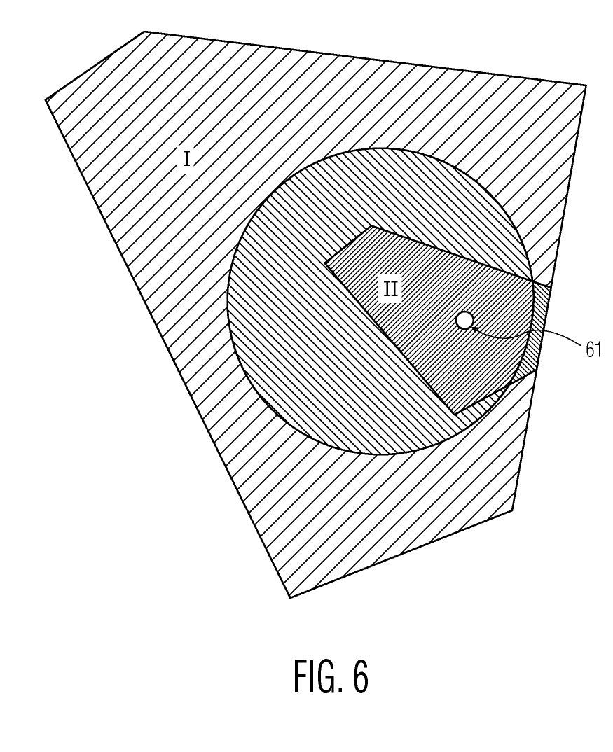

FIGS. 6-9 illustrate how the minimum and maximum area estimates are combined to determine the total boundary area of an object;

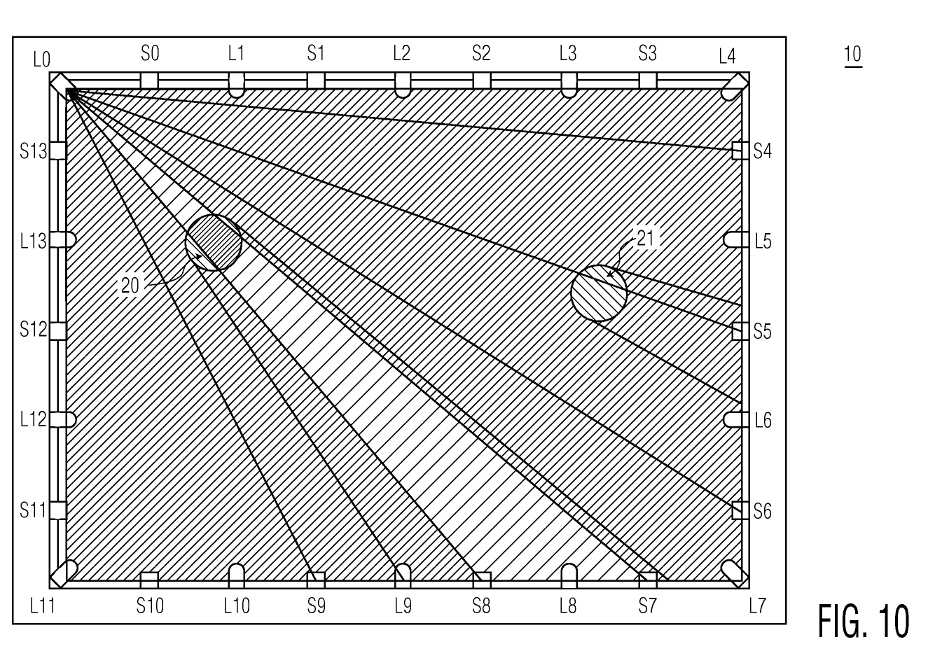

FIG. 10 illustrates a snapshot of the touch screen display 10 in the operational mode during the turn-on time of a first corner light source L₀ in the presence of two circular objects;

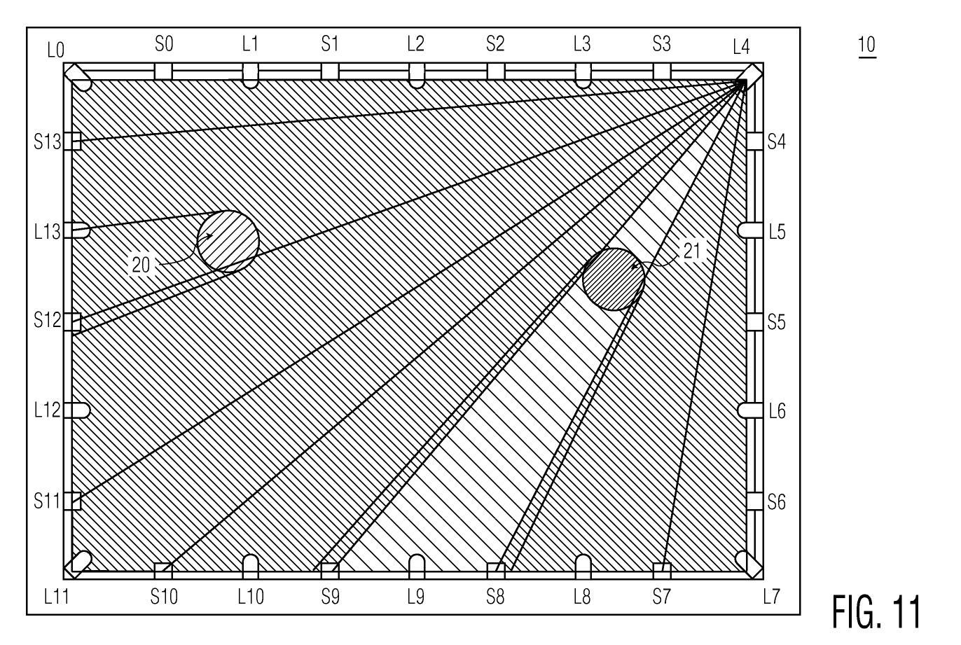

FIG. 11 illustrates a snapshot of the touch screen display in the operational mode during the turn-on time of a second corner light source L₁ in the presence of two circular objects;

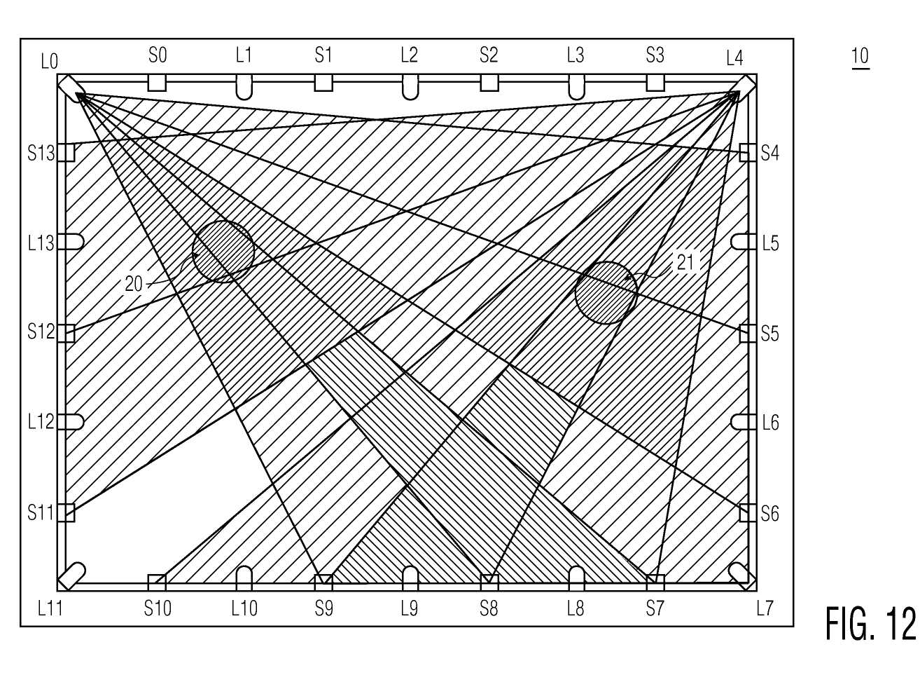

FIG. 12 illustrates how the minimum and maximum area estimates are calculated for the “optimized” approach;

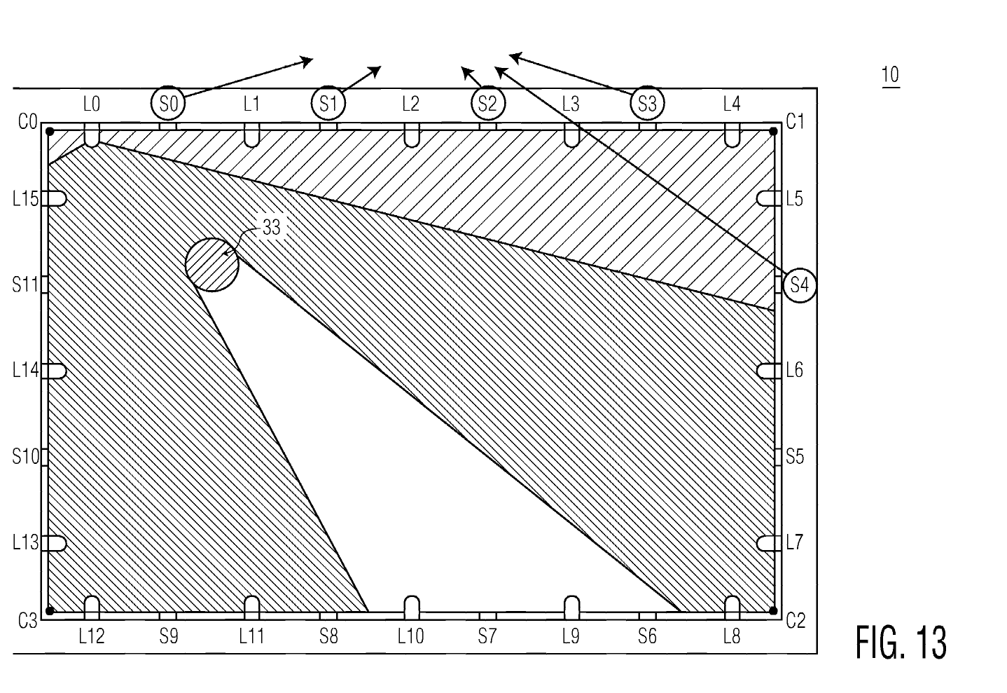

FIGS. 13-15 illustrate snapshots of the touch screen display which illustrate the measurement of light reflection, absorption and transmission of one object;

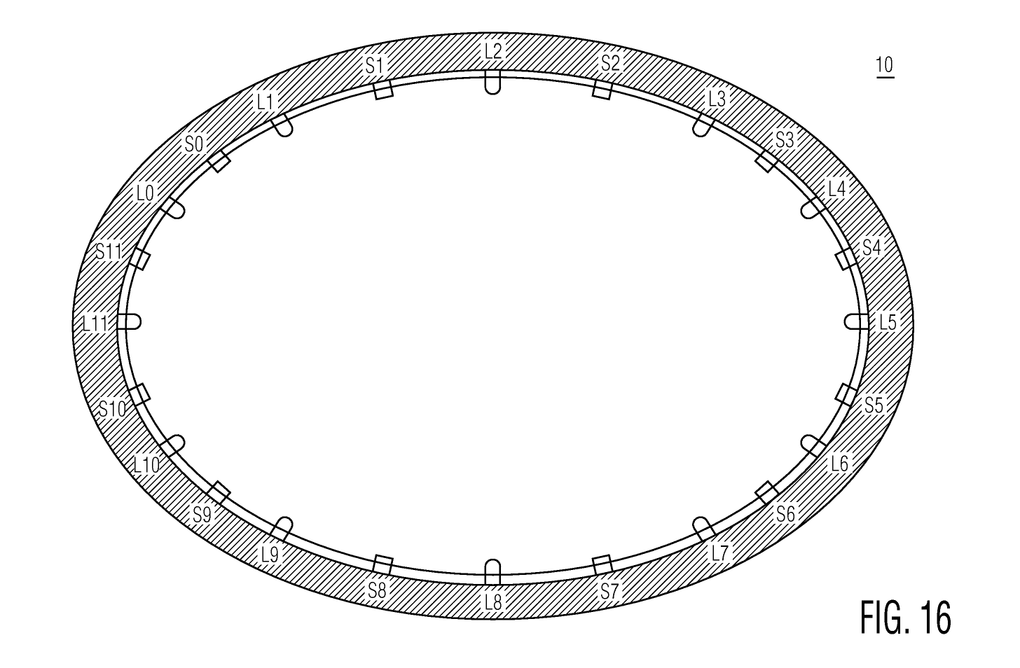

FIG. 16 illustrates a touch screen having an oval shape, according to an embodiment of the invention;

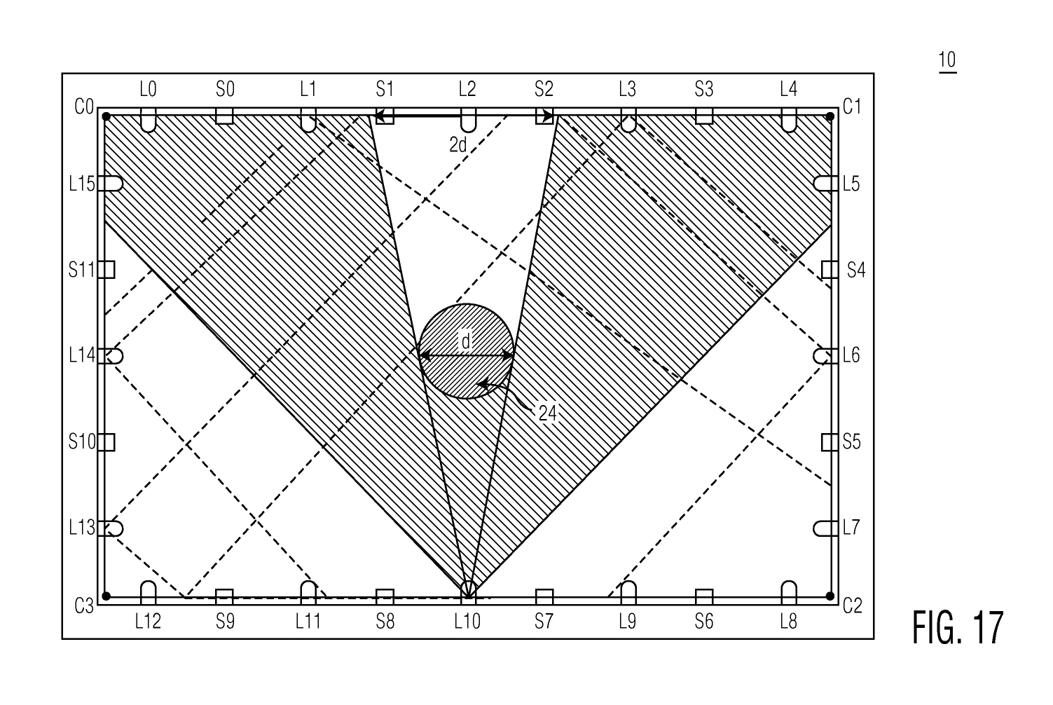

FIG. 17-21 illustrate how the difference in the object location on the touch screen can impact the object location, shape, size detection precision; and

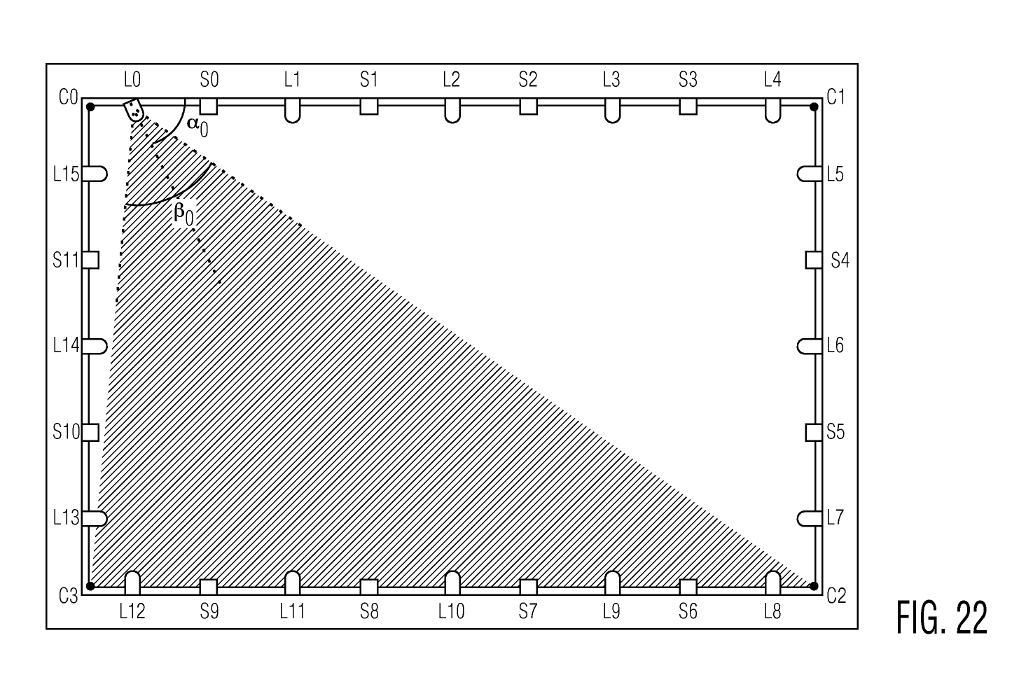

FIG. 22-25 illustrate an embodiment where different angular positions are selected for the light transmitters.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention.

Although the invention is described and illustrated herein in conjunction with a touch screen (i.e., a display with embedded touch sensing technology), the invention does not require the use of a display screen. Rather, the invention may be used in a standalone configuration without including a display screen.

It should also be appreciated that the use of the word ‘touch screen’ throughout this specification is intended to imply all other such XY implementations, applications, or modes of operation with or without a display screen. It should also be appreciated that the invention is not restricted to using infrared light transmitters only. Any kind of light source, visible or invisible, can be used in combination with appropriate detectors. Using light transmitters that emit visible light can give an extra advantage in some cases since it provides visual feedback on the object placed within the touch screen. The visual feedback in such case is the light from the transmitters terminated by the object itself.

As will be described in detail below, the switching order of the light transmitters may be different in different embodiments depending upon the intended application.

Advantages of the detection method of the invention include, but are not limited to, simultaneous detection of multiple objects including, for example, a hand or hands, a finger or fingers belonging to a single and/or multiple users, thereby making the invention applicable to conventional touch screen applications in addition to the creation of new touch screen applications. The ability to detect hands and/or objects allows users to enter information such as size, shape and distance in a single user action, not achievable in the prior art.

The ability to simultaneously detect multiple objects, hands and/or fingers on the touch screen allows multiple users to simultaneously interact with the touch screen display or allowing single users to simultaneously interact with the touch screen display using two hands.

The remainder of the detailed description is organized in the following manner.

First, a detailed description of a method for detecting the size, shape and location of one or more objects interacting with an infrared optical touch screen display is provided. The description includes an illustrative example of how calibration is performed and the calculation of an object boundary area in a non-calibration mode including the acts of computing minimum and maximum boundary area estimates.

Second, a detailed description of techniques for performing object recognition is provided.

Third, a detailed description of different switching schemes is provided.

Fourth, a detailed description of an energy saving or idle mode is provided.

Fifth, a detailed description of identifying objects based on the objects optical properties is provided.

Sixth, a detailed description of various screen shapes and configurations is provided.

Seventh, a detailed description of how the difference in object location on the touch screen can impact the object location, shape and size detection precision is provided.

Eight, a detailed description of the different angular positions that may be selected for the light transmitters is provided.

FIG. 1 illustrates an infrared optical touch screen display 10, according to one embodiment. The touch screen display 10 includes on its periphery, N light transmitters, L₀-L₁₅, where N=16, which may be embodied as lamps, LEDs or the like, and M sensors (i.e., light detectors) S₀-S₁₁, where M=12. The light transmitters and sensors being arranged in an alternating pattern (e.g., L₀, S₁, L₁, S₂, . . . , L₁₅, S₁₁). It should be appreciated that the number and configuration of light transmitters and sensors may vary in different embodiments.

By way of example, a method for detecting the position, shape and size of objects is now described, according to the infrared optical touch screen display apparatus illustrated in FIG. 1.

The method to be described is generally comprised of two stages, a calibration stage and an operational stage.

Calibration Stage

Calibration is performed to collect calibration data. Calibration data is comprised of sensor identification information corresponding to those sensors which detect a light beam transmitted from each of the respective light transmitters located on the periphery of the touch screen display 10 during a turn-on time of each light transmitter. The turn-on time is defined herein as the time during which light emanates from a respective light transmitter in a switched on state. It should be appreciated that in order to obtain meaningful calibration data, it is required that no objects (e.g., fingers, stylus, etc.) interact with the transmission of the light beams during their respective turn-on times in the calibration mode.

During the calibration stage, as each light transmitter is switched on during its respective turn-on time, the light beam that is cast may be detected by certain of the sensors S₀-S₁₁ located on the periphery of the touch screen display 10 and may not be detected by certain other sensors. For each light transmitter, L₀-L₁₅, the identification of the sensors S₀-S₁₁ that detect the respective light transmitter's light beam is recorded as calibration data.

An illustrative example of calibration data collected for the optical touch screen display 10 of FIG. 1 is shown in Table I below. The calibration data shown is recorded as a plurality of sequential record entries. Each record entry is comprised of three columns: a first column which illustrates the identification of one of the light transmitters Lᵢ located on the periphery of the touch screen, a second column illustrating the sensors that are illuminated by the corresponding light transmitter (i.e., detect the light beam) during its respective turn-on time, and a third column illustrating the sensors that are not illuminated by the corresponding light source during its respective turn-on time. It is noted that the data of the third column may be derived from the data of the second column as a corollary to the data in the second column. For example, the non-illuminated sensors (column 3) may be derived as the difference between the original sensor set {S₀, S₁, . . . S₁₁} and the illuminated sensors (column 2).

With reference now to the first record entry of Table I, it is shown that, during the calibration stage, during the turn-on time of illuminating light transmitter L₀, sensors S₅-S₁₁ are illuminated and sensors S₀-S₄ are not illuminated.

TABLE I
(Calibration Data)

| ILLUMINATING | | |
|---|---|---|
| LIGHT | ILLUMINATED | NON-ILLUMINATED |
| TRANSMITTER | SENSORS | SENSORS |
| L0 | S5-S11 | S0-S4 |
| L1 | S4-S11 | S0-S3 |
| L2 | S4-S11 | S0-S3 |
| L3 | S4-S11 | S0-S3 |
| L4 | S4-S10 | S11-S3 |
| L5 | S6-S3 | S4-S5 |
| L6 | S6-S3 | S4-S5 |
| L7 | S6-S3 | S4-S5 |
| L8 | S11-S5 | S6-S10 |
| L9 | S10-S5 | S6-S9 |
| L10 | S10-S5 | S6-S9 |
| L11 | S10-S5 | S6-S9 |
| L12 | S10-S4 | S5-S9 |
| L13 | S0-S9 | S10-S11 |
| L14 | S0-S9 | S10-S11 |
| L15 | S0-S9 | S10-S11 |

Calibration is described as follows. At the start of calibration, each of the respective light transmitters L₀-L₁₅ located on the periphery of the touch screen display 10 are switched to an off state. Thereafter, each of the light transmitters L₀-L₁₅ is switched on and off for a pre-determined turn-on time. For example, light transmitter L₀ is switched on first for a pre-determined turn-on time during which calibration data is collected. Light transmitter L₀ is turned off. Next, light transmitter L₁ is switched on for a pre-determined time and calibration data is collected. Light transmitter L₀ is turned off. This process continues in a similar manner for each of the remaining light transmitters in the periphery of the touch screen, e.g., L₂-L₁₅, the end of which constitutes the completion of calibration.

As each light transmitter L₀-L₁₅ in the calibration sequence is turned-on, a beam of light is transmitted having a characteristic two-dimensional spatial distribution in a plane of the touch screen display 10. It is well known that depending upon the particular transmitter source selected for use, the spatial distribution of the emitted light beam will have a different angular width. Selecting a light transmitter having a light beam of a particular angular width may be determined, at least in part, from the intended application. That is, if it is expected that the objects to be detected in a particular application are particularly large having significant width, then light transmitters having a spatial distribution wider than the object itself are more appropriate for that application.

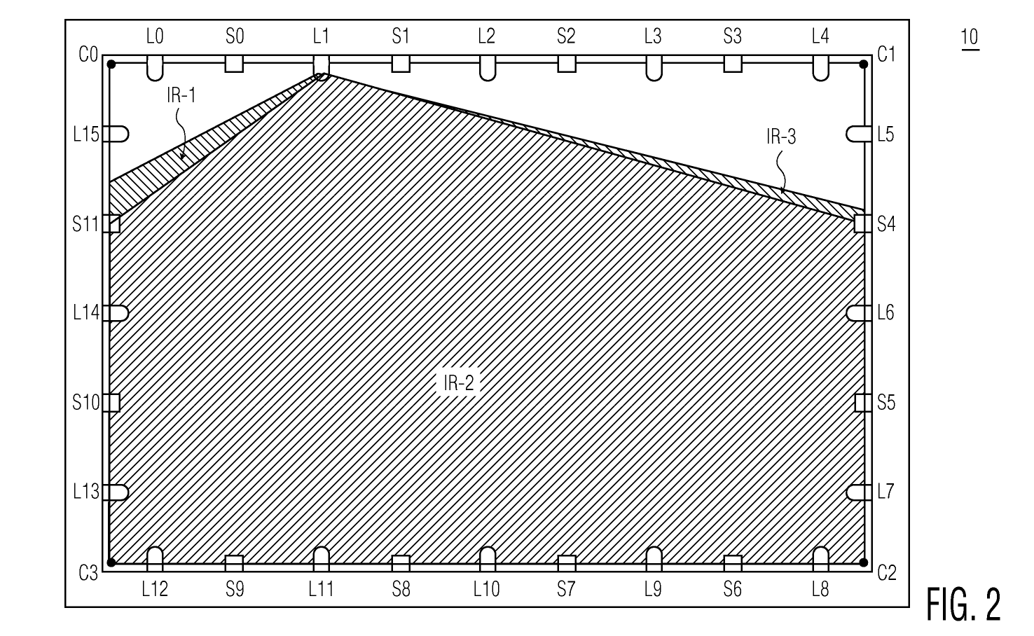

FIGS. 1 and 2 correspond, respectively, to snapshots of light beams that are transmitted by the first and second light transmitters, L₀ and L₁, during their respective turn-on times during calibration. FIG. 1 corresponds to a snapshot of a light beam transmitted from light transmitter L₀ during its respective turn-on time and FIG. 2 corresponds to a snapshot of a light beam transmitted from light transmitter L₁ during its respective turn on time.

Referring now to FIG. 1, which illustrates a snapshot of the touch screen display 10 during the turn-on time of the light transmitter L₀. As shown, the light transmitter L₀ shines a distinctive beam of light having a two-dimensional spatial distribution that defines a lit area in a plane of the touch screen. For ease of explanation, the area illuminated by the light transmitter L₀ is considered to be comprised of three constituent regions, labeled as illuminated regions (IR-1), (IR-2) and (IR-3), respectively.

Referring now to the second illuminated region, IR-2, this region is defined as being bounded in the plane of the touch screen by the outermost sensors (S₅ and S₁₁) capable of detecting the light beam from the light transmitter L₀. It is noted that illuminated regions IR-1 and IR-3 also fall within the illuminated region of the plane of the touch screen, but are separately labeled because they both fall outside the region of detection of the outermost sensors (S₅ and S₁₁) capable of detecting the light beam from light source L₀. The outermost sensor detection information, e.g., the sensor range (S₅-S₁₁) is recorded as part of the calibration data (see the first row entry of Table I above, “outermost illuminated sensors”). As discussed above, the calibration data may additionally include the identification of those sensors that do not detect the light from the light source L₀, which in the instant example, are defined by the sensor range S₀-S₄ as a corollary to the detection information.

After recording the calibration data for light source L₀, it is switched off at the end of its turn-on time and the next light source in the sequence, the light source L₁, is switched on for its respective turn-on time.

FIG. 2 is an illustration of a snapshot of the touch screen display 10 during a point in time at which the next light source L₁ in the sequence is switched on during calibration. As shown in FIG. 2, the light source L₁ shines a distinctive beam of light having a distinctive coverage pattern in the plane of interest based on its position in the periphery of the touch screen display 10. For ease of explanation, the area lit by the light source L₁ may be considered to be comprised of 3 spatial regions, regions IR-1, IR-2 and IR-3, similar to that discussed above for light source L₀.

Referring first to the second spatial region, IR-2, this region is bounded by the outermost sensors that detect the light beam from the light source L₁, i.e., outermost sensors S₄ and S₁₁. Regions IR-1 and IR-3 fall within the lit area of the plane of the touch screen but fall outside the region of detection of the outermost sensors (S₄ and S₁₁) capable of detecting the light beam from L₁. This sensor detection information is recorded as part of the calibration data (as shown in the second row entry of Table I above). As discussed above, the calibration data may additionally include the identification of those sensors that do not detect the light transmitted from the light transmitter L₁, namely, sensor range S₀-S₃.

After recording the sensor information from the light transmitters L₀ and L₁ in the manner described above, the calibration process continues in a similar manner for each of the remaining light transmitters located in the periphery of the touch screen, namely, the light transmitters L₂-L₁₅.

As will be described further below, the calibration data is used together with non-calibration data acquired during an operational stage to detect the position, shape and size of one or more objects interacting with the touch screen display 10.

Operational Stage

After calibration is complete, the touch screen display 10 is ready for use to detect the position, shape and size of one or more objects interacting with the touch screen display 10.

In accordance with the present illustrative embodiment, detection of the position, shape and size of one or more objects interacting with the touch screen display 10 is performed continuously over multiple cycles of operation. For example, in the illustrative embodiment, each of the light transmitters L₁-L₁₅ illuminates in a pre-determined sequence constituting a single cycle of operation which is repeated over multiple cycles of operation.

Similar to that described above for calibration, a single cycle of operation in the operational stage starts with the light source L₀ being turned on for a pre-determined turn-on time. After L₀ turns off, light source L₁ is turned on for a pre-determined turn-on time. This process continues in a similar manner for each light transmitter and ends with light transmitter L₁₅, the last light transmitter in the sequence.

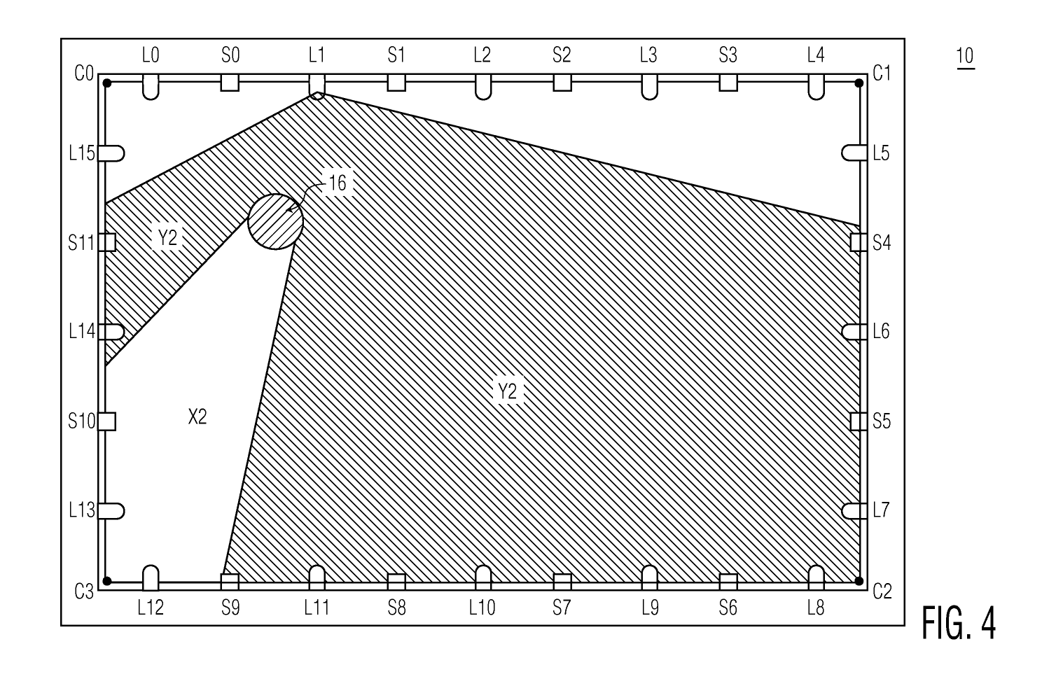

FIGS. 3 and 4 illustrate two steps of a single cycle of operation in the operational mode, for the presently described exemplary embodiment. FIGS. 3 and 4 illustrate a snapshot of light beams transmitted from light transmitters L₀ and L₁, respectively, in the presence of a single circular object 16. A single circular object 16 is selected for simplicity to illustrate the operational stage.

FIG. 3 illustrates a snapshot of the touch screen display 10 in the operational mode during the turn-on time of the light transmitter L₀ in the presence of the circular object 16. In each cycle of operation, during the turn-on time of the light transmitter L₀, the light transmitter shines a distinctive beam of light having a two-dimensional coverage pattern in a plane of the touch screen display 10.

For purposes of explanation, the light distribution pattern of the light transmitter L₀ is considered to be comprised of two regions, a first illuminated region labeled Y1 and a second non-illuminated (shadow) region labeled X1.

The illuminated region Y1 defines an area that is not subjected to the shadow cast by the circular object 16 when illuminated by the light transmitter L₀. The non-illuminated (shadow) region X1 identifies an area that is subjected to the shadow cast by the circular object 16 when illuminated by the light transmitter L₀. The non-illuminated (shadow) region X1 includes sensors S₆ and S₇ on the touch screen display 10 which detect an absence of light during the turn-on time of the light source L₀. This sensor information is recorded as part of the non-calibration data for the current cycle of operation for the present position of the circular object 16 as shown in FIG. 3.

In a single cycle of operation, after the light source L₀ is turned off at the end of its respective turn-on time, the next light source in the sequence L₁ is turned-on for its pre-determined turn-on time. This is illustrated in FIG. 4, described as follows.

Referring now to FIG. 4, it is shown that light transmitter L₁ shines a distinctive beam of light having a two-dimensional coverage pattern on the touch screen display 10. For purposes of explanation, the light distribution pattern of the light transmitter L₁ is considered to be comprised of 2 regions, an illuminated region labeled Y2 and a non-illuminated (shadow) region labeled X2. The illuminated region Y2 defines an area that is not subjected to the shadow cast by the circular object 16 when illuminated by the light transmitter L₁. The non-illuminated (shadow) region X2 identifies an area that is subjected to the shadow cast by the circular object 16 when illuminated by the light transmitter L₁. The illuminated region Y2 includes all sensors except sensor S₁₀. The non-illuminated (shadow) region X2 includes only sensor S₁₀ on the touch screen display 10 which detects an absence of light during the turn-on time of the light transmitter L₁. This sensor information is recorded as part of the non-calibration data for the current cycle of operation for the present position of the circular object 16 as shown in FIG. 4.

The process described above for light transmitters L₀ and L₁, in the operational mode, continues in the manner described above for each of the remaining light transmitters L₂-L₁₅ in the current cycle of operation.

Table II below illustrates, by way of example, for the present illustrative embodiment, the non-calibration data that is recorded over a single cycle of operation in the presence of the circular object 16 for light sources L₀-L₂. For ease of explanation, table II only shows non-calibration data for three of the sixteen sensors, for a single cycle of operation.

TABLE II
(Non-Calibration Data)

| ILLUMINATING | SENSORS | SENSORS NOT |
|---|---|---|
| LIGHT SOURCE | ILLUMINATED | ILLUMINATED |
| L0 | S5 &(S8-S11) | (S0-S4) &(S6-S7) |
| L1 | (S4-S9) &S11 | (S1-S3) &S10 |
| L2 | (S4-S11) | (S2-S3) &(S0-S1) |
| . | | |
| . | | |
| . | | |
| . | | |
| . | | |
| . | | |
| . | | |
| . | | |
| . | | |
| L15 | | |

While only a single cycle of operation is discussed above for the operational mode, it should be understood that the operational mode is comprised of multiple cycles of operation. Multiple cycles are required to detect changes in location, size and shape of objects on the screen from one point in time to the next, but also to detect the addition of new objects or removal of already present objects.

### Minimum and Maximum Area Estimates

During each cycle of operation in the operational mode, minimum and maximum area estimates are made for the detected objects. The estimates are stored in a data repository for later recall in detecting an object boundary area.

Minimum and maximum area estimates are made for each light transmitter (N) located in the periphery of the touch screen. In the present illustrative embodiment, N=16 minimum area estimates are made and N=16 maximum area estimates are made in each cycle of operation.

Upon completing a single cycle of operation, the minimum and maximum area estimates are retrieved from the data repository and combined in a manner to be described below to determine an object boundary area for each detected object in the plane of the touch screen.

The computation of a minimum and maximum area estimate for the first and second light transmitters L₀ and L₁ for a single cycle of operation are now described with reference to FIG. 5.

### Minimum and Maximum Area Estimates for Light Source L₀

Referring now to FIG. 5, a derivation of a minimum and maximum area estimates for light transmitter L₀ are illustrated. To compute a minimum and maximum area estimate, the previously collected calibration data and non-calibration data is used to assist in the computation.

Recall that the calibration data for light transmitter L₀ was found to be the range of illuminated sensors (S₅-S₁₁). This sensor range constitute those sensors capable of detecting a presence of light from the light transmitter L₀ during calibration (as shown in the first row of Table I).

Recall that the non-calibration data for light transmitter L₀ in the presence of the circular object 16 was found to be the sensor ranges (S0-S4) & (S6-S7) detecting an absence of light (as shown in Table II above and illustrated in FIG. 3).

Next, a comparison is made of the calibration data and non-calibration data. Specifically, knowing that sensors S6-S7 detect an absence of light during the non-calibration mode and knowing that sensors S5-S11 are illuminated during calibration, the shadow area cast by the object 16 can be determined. This is illustrated now with reference to FIG. 5.

FIG. 5 illustrates that the circular object 16 blocks the light path between the light source L₀ and sensor S₆ (see dashed line P5) and is also shown to be blocking the light path between the light transmitter L₀ and sensor S₇ (see dashed line P6). FIG. 5 further illustrates that the object 16 does not block the light paths between the light transmitter L₀ and the sensors S₅ (line P1) and S₈ (line P2). This information, derived from the calibration and non-calibration data, is summarized in Table III and used to determine the minimum and maximum area estimates for the object 16.

TABLE III

| PATH | Light Path {Blocked/Not Blocked} |
|---|---|
| L₀ to sensor S5 | Not Blocked (see line P1 ) |
| L₀ to sensor S6 | Blocked (see line P5) |
| L₀ to sensor S7 | Blocked (see line P6) |
| L₀ to sensor S8 | Not Blocked (see line P2) |

Based on the information summarized in Table III above, a minimum area estimate can be determined as follows. The circular object 16 blocks the light path between the light source L₀ and sensors S₆ (see line P5) and S₇ (see line P6). Therefore, the minimum area estimate of object 16, labeled MIN, during the turn-on time of light source L₀ is defined by the triangle shown in FIG. 5 defined by points {L₀, S₇, S₆} having two sides defined by the lines P5 and P6.

Minimum Area Estimate for L₀ of object 16=triangle {L₀, S₇, S₆}

It should be understood that triangle {L₀, S₇, S₆} represents the best minimum area estimate given the uncertainty introduced by the distance between the respective sensors S₇ and S₈ and the distance between the respective sensors S₆ and S₅.

Using Table III above, a maximum area estimate of object 16, labeled MAX, for light transmitter L₀ may be defined in a similar manner. Using the information from Table III, the maximum area estimate is defined by points {L₀, S₅, C₂, S₈}. This area is derived by including the sensors S₅ and S₈ adjacent to the shadow area detected with the sensors S₆-S₇. It should be noted here that the area includes corner C₂ because the line between S₅ and S₈ should follow the boundary of the screen.

Maximum Area Estimate for L₀ of object 16=Area bounded by {L₀, S₅, C₂, S₈}

Due to the uncertainty introduced by the distance between the respective sensors S₆ and S₅ and the distance between the respective sensors S₇ and S₈, it is reasonable to assume that the object 16 could be covering the area between lines P1 and P2, corresponding to sensors S₅ and S₈, respectively.

The minimum and maximum area estimates, once determined, are stored in a data repository for each light transmitter for the current cycle of operation. The process of determining a minimum and maximum area continues in a similar manner for each of the remaining light transmitters L₂-L₁₅. Further, the minimum and maximum area results are preferably stored in the data repository as geometrical coordinates, such as, for example, the geometrical coordinates of the min and max area vertexes or coordinates of the lines corresponding to area facets.

After a complete cycle of operation, the stored minimum and maximum area estimates are retrieved from the data repository and combined to determine the object boundary area of object 16, as described below.

### Object Boundary Area Calculation

The method by which the minimum and maximum area estimate results are combined to determine an object boundary area may be performed in accordance with one embodiment, as follows.

The maximum area estimates for each of the N light transmitters Lᵢ (e.g., L₀-L₁₅), over one cycle of operation, are combined through a mathematical intersection as shown in equation (1) below, to derive a maximum area result, A_{Total}_{ₘₐₓ}. It is noted that areas that do not have a surface (e.g. empty areas or lines) are excluded from the calculation of A_{Total}_{ₘₐₓ}.

$${A}_{{Total}_{max}} = \{ \begin{matrix} ∅ , & if {A}_{{L}_{{0}_{max}}} = {A}_{{L}_{{1}_{max}}} = … = {A}_{{L}_{{N}_{max}}} = 0 \\ {{⋂}^{N - 1} {A}_{{L}_{{i}_{max}}} ,}_{i = 0 , {A}_{{L}_{{i}_{max}}} \neq ∅} & otherwise\end{matrix} \qquad ( 1 )$$

The minimum area estimates for each of the N light transmitters Lᵢ (e.g., L₀-L₁₅), over one cycle of operation, are similarly combined through a mathematical intersection, as shown in equation (2) below, to derive a minimum area result, A_{Total}_{ₘᵢₙ}.

It is noted that areas that do not have a surface (e.g. empty areas or lines) are excluded from the calculation of A_{Total}_{ₘᵢₙ}.

$${A}_{{Total}_{min}} = \{ \begin{matrix} ∅ , & if {A}_{{L}_{{0}_{min}}} = {A}_{{L}_{{1}_{min}}} = … = {A}_{{L}_{{N}_{min}}} = 0 \\ ( {{⋂}^{N - 1} {A}_{{L}_{{i}_{min}}}}_{i = 0 , {A}_{{L}_{{i}_{min}}} \neq ∅} ) ⋂ {A}_{{Total}_{max}} , & otherwise \end{matrix} \qquad ( 2 )$$

As it is shown in equation (2), after both, A_{Total}_{ₘₐₓ} and A_{Total}_{ₘᵢₙ}, have been calculated, the minimum area result A_{Total}_{ₘᵢₙ} is then combined through a mathematical intersection with the maximum area result A_{Total}_{ₘₐₓ} to ensure that the minimum area is completely inside the maximum area. In other words, any portion of the minimum area that falls outside the boundary of the computed maximum area will be ignored. This may occur because not all snapshots result in sufficient input for minimum and maximum area calculations, it is possible that part of the minimum area will fall outside the maximum area. For example, in a situation where the maximum area estimate for a particular light transmitter results in a snapshot that is bounded by only 2 sensors, the minimum area will be empty. Therefore, the particular light transmitter will only produce input for the maximum area calculation. If a small enough object is used on the touch screen, a relatively large number of detection results will fall into this category, i.e., producing input for the total maximum area calculation but not the total minimum area calculation. This will result in a reasonably defined total maximum area and a poorly defined total minimum area, which is an intersection of only a few minimum areas.

To compensate for this problem it is required that the total minimum area is contained within the total maximum area, because it is known that the object can never be outside the total maximum area.

A_{Total}_{ₘᵢₙ} and A_{Total}_{ₘₐₓ} can contain several sub areas that fall under the definition of a closed set indicating that there are several objects present. Closed sets are described in greater detail in Eric W. Weisstein. “Closed Set.” From MathWorld—A Wolfram Web Resource, http://mathword.wolfram.com/GeometricCentroid.html.

Other resources include Croft, H. T.; Falconer, K. J.; and Guy, R. K. Unsolved Problems in Geometry New York: Springer-Verlag, p. 2, 1991 and Krantz, S. G. Handbook of Complex Variables Boston, Mass.: Birkhäuser, p. 3, 1999.

Area A_{Total}_{ₘᵢₙ} can be divided in several sub areas [symbol] in such a way that

A_{Total}_{ₘᵢₙ}=∪ [symbol] (3a) and

so that every [symbol] is a closed set that corresponds to a particular object

Similarly, area A_{Total}_{ₘₐₓ} can be divided in several sub areas [symbol] in such a way that

A_{Total}_{ₘₐₓ}=∪ [symbol] (3b) and

so that every [symbol] is a closed set that corresponds to a particular object

The total boundary of a single object j A_{Total}_{ⱼ} (4), also referred to as the shape of object j, and can be defined as:

A_{Total j}=F( [symbol] , [symbol] ) (4)

for each [symbol] ⊂

[symbol]

Where F is the function or method of finding A_{Total}_{ⱼ}. One possibility of finding the A_{Total}_{ⱼ} is described in detail below.

Referring now to FIG. 6, which illustrates a method for combining the minimum [symbol] and maximum, [symbol] areas to approximate the actual boundary of an object 16.

To approximate the actual boundary of the object 16, we start by determining the center of gravity 61 of the minimum area, labeled II. The method for determining the center of gravity of an object is described in greater detail in Eric W. Weisstein. “Geometric Centroid.” From MathWorld—A Wolfram Web Resource which can be found on the Internet at http://mathword.wolfram.com/GeometricCentroid.html. Other resources for determining the center of gravity 61 of the minimum area (II) include Kern, W. F. and Bland, J. R. “Center of Gravity.” §39 in Solid Mensuration with Proofs, 2nd ed. New York: Wiley, p. 110, 1948 and McLean, W. G. and Nelson, E. W. “First Moments and Centroids.” Ch. 9 in “Schaum's Outline of Theory and Problems of Engineering Mechanics Statics and Dynamics”, 4^{th} ed., New York: McGraw-Hill, pp. 134-162, 1988.

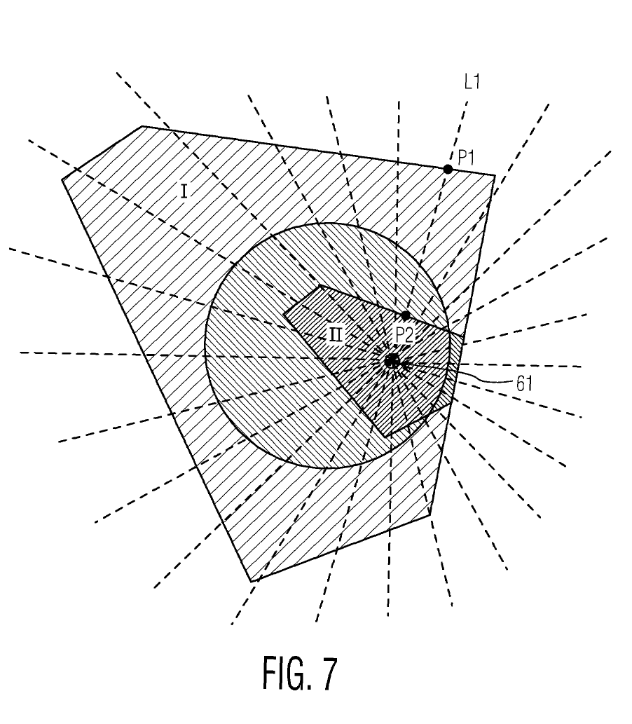

Referring now to FIG. 7, having previously found the center of gravity 61, multiple lines are drawn from it. Each line will intersect the border of the maximum area (I) and the border of the minimum area (II). For example, line L1 intersects the minimum area (II) at its border through points P2 and further intersects the maximum area (I) at its border through points P1.

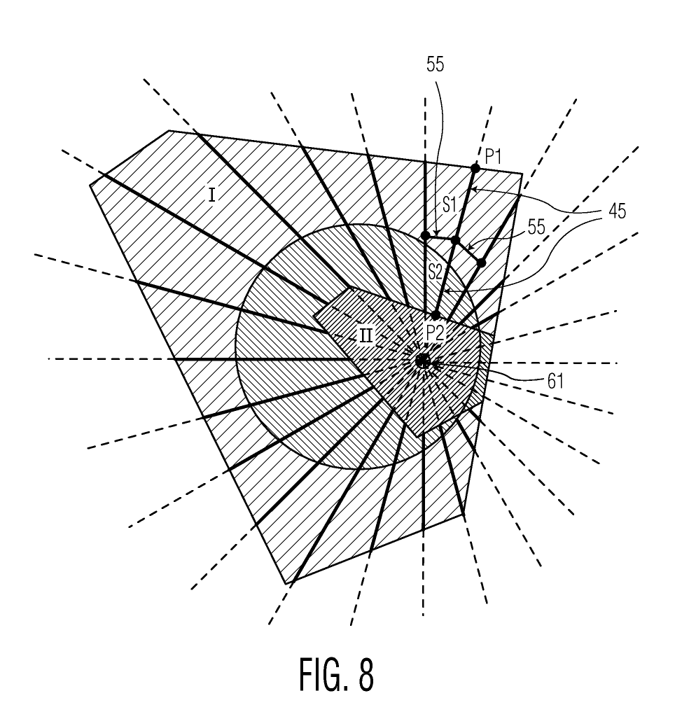

Referring now to FIG. 8, points P1 and P2 are shown connected by a line segment 45 bifurcated at its midpoint 62 into two equal length line segments S1 and S2. This process is repeated for each line. Line segments 55 are then drawn that connect all the middle points of adjacent line segments.

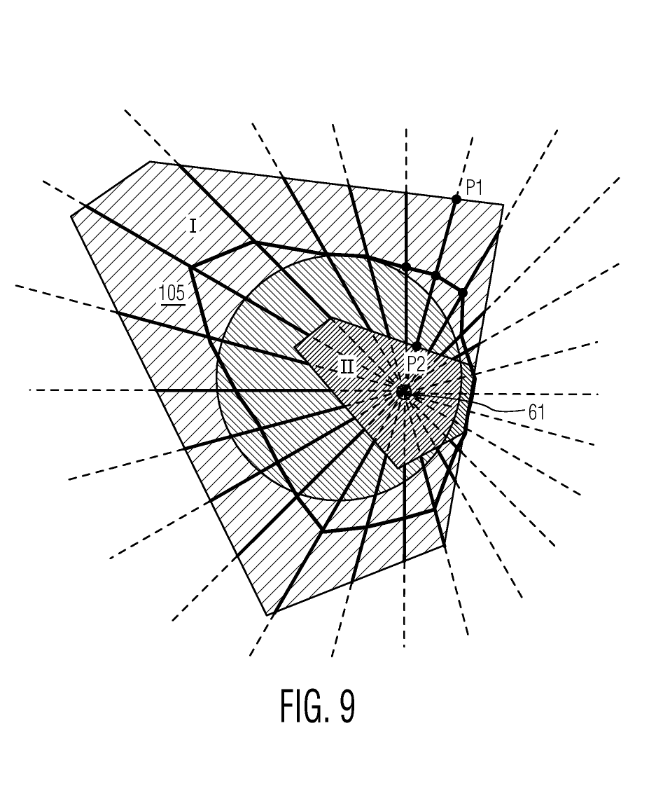

FIG. 9 illustrates a boundary area, defined by a boundary border 105, that is formed as a result of connecting all of the midpoints of the adjacent line segments. This boundary area essentially forms the approximated boundary of the object.

In alternative embodiments, it is possible to derive the approximated object boundary by taking, instead of the middle point of the line segments 45 as shown in other ratios for finding the dividing point 62. Those ratios can be for example 5:95, 30:70, etc. These ratios can be defined in accordance with the intended application.

Other parameters than can be derived for each object j include the object's area, position and shape:

$${area}_{j} = {\int }_{area}^{ } {A}_{{Total}_{j}}$$

positionⱼ=center of gravity of A_{Total}_{ⱼ}

Reference points other than the center of gravity of an object may also be derived, such as, for example, the top left corner of an object or a bounding box.

shape=A_{Total}_{ⱼ}

It is noted that the shape being detected is the convex hull shape of the object on the screen that excludes internal cavities of an object if those are present.

In addition to computing the boundary, area, position and shape of an object, it is also possible to calculate the object's size. The size of an object can be calculated in different ways for different geometrical figures. However, for any geometrical figure, the maximum size of the geometrical figure along the two axis, x and y, i.e., Maxₓ and Max_{y} may be determined. In most cases, the detected geometrical figure is a polygon in which case, Maxₓ can be defined as the maximum cross section of the resulting polygon taken along the x-axis and Max_{y} as the maximum cross section of the same polygon along the y-axis.

Another method for determining the size of an object is by providing a unique definition of size for a number of common geometrical shapes. For example, defining the size of a circle as its diameter, defining the size of a square as the length of one of its sides and defining the size of a rectangle as its length and width.

As described above, the present invention provides techniques for the detection of one or more objects based on the object's size and/or shape. Accordingly, for those applications that utilize objects of different sizes and/or shapes, the invention provides an additional capability of performing object recognition based on the object's detected size and/or shape.

Techniques for performing object recognition include utilizing a learning mode. In the learning mode, a user places an object on the surface of the touch screen, one at a time. The shape of the object placed on the surface of the touch screen is detected in the learning mode and object parameters including shape and size are recorded. Thereafter, in the operational mode, whenever an object is detected, its shape and size are analyzed to determine if it matches the shape and size of one of the learned objects, given an admissible deviation delta defined by the application. If the determination results in a match, then the object can be successfully identified. Examples of object recognition include recognition of pawns of a board game with a different shape or recognition of a users hand, when placed on the touch screen.

For standard shapes, such as triangle, square, etc., the standard shape parameters may be provided to the control software, so that when a similar object form is detected it can be recognized as such by the system.

Switching Schemes

According to another aspect of the present invention, different switching schemes are contemplated for switching the light transmitters on and off. A few exemplary switching schemes are described below. It is noted, however, that the described schemes are merely illustrative. The astute reader will recognize that there are many variants to the schemes described below.

A.—Plain Switching Scheme

The plain switching scheme has already been described above with reference to the illustrative embodiment. In accordance with the “plain” switching scheme, each light transmitter (e.g., L₁-L₁₅) is turned on and off in a sequence around the periphery of the touch screen 10 (FIG. 3-5) constituting a single cycle of operation. The sequence can be initiated with any light transmitter. Further, once initiated, the sequence can proceed in either a clockwise or counterclockwise direction.

B.—Optimized Switching Scheme

Another switching scheme, which produces, in most cases, the most information about objects present on the screen early in the operational stage is referred to herein as an ‘optimized’ switching scheme. In accordance with this scheme, certain of the light transmitters are uniquely positioned in the corners of the touch screen and are directed towards the middle of the touch screen. This is a desirable positioning and orientation because a corner light transmitter lights up the entire touch screen and thus provides maximum information. The non-corner light sources, by comparison, only illuminate a part of the touch screen, thereby providing information over only a portion of the touch screen. The inventors have recognized that if the light sources which are most likely to produce the most information (i.e., the corner light sources) are used first, more information would be available at an earlier stage of the detection process. This could result in the analysis of intermediate results, which are used to adapt a subsequent switching scheme for switching the rest of the light transmitters on and off. As a consequence, it could be the case that the detection process can be completed faster and with less steps involved without having to switch all the light transmitters on and off, since sufficient information may be obtained with strategically selected transmitters. This could result in a faster response and/or energy savings.

FIG. 10 illustrates a snapshot of the touch screen display 10 in the operational mode during the turn-on time of a first corner light source L₀ in the presence of two circular objects 20 and 21. As shown, the light transmitters L₁, L₄, L₇ and L₁₁ in each of the respective corners of the touch screen 10 are oriented towards the center of the touch screen 10. With particular reference to the light source L₀, by virtue of its strategic orientation and being a corner light transmitter, it is capable of detecting both objects 20, 21.

In accordance with the optimized scheme, light transmitter L₀ positioned in the upper left corner of the touch screen is switched on first since this light transmitter emits light over the total touch screen area thereby likely producing the most information. However, the optimized scheme can be started by switching any of the corner light transmitters (e.g. L₀, L₄, L₇, L₁₁) since they would produce equal amount of information.

Referring back to FIG. 1, it is shown that the light emanating from the transmitter L₀ positioned in a ‘normal’ orientation along the frame edge, only covers a portion of the touch screen labeled IR1, IR2 and IR3 and does not cover the remaining portion of the touch screen 10 shown in white.

Referring again to FIG. 10, by way of comparison, the light emanating from the transmitter L₀ oriented towards the center of the touch screen 10 and positioned in the corner advantageously covers the entire screen by virtue of its orientation and position including the white areas not covered in FIG. 1.

FIG. 11 illustrates the result of turning on the light transmitter L₄ in the sequence after switching off L₀. L₄ is located in the upper right corner of the touch screen 10 and emits light over the whole area of touch screen 10. As such, it is capable of detecting both objects 20, 21.

In those cases where the object(s) are positioned close to L₀ or L₄, light transmitters L₁₁ and L₇ may be employed in addition to light transmitters L₀ and L₄. In the general case, minimum and maximum area estimates are calculated after light transmitter L₄ is switched off, the result of which is illustrated in FIG. 12. Two areas are shown, the boundaries of which are roughly known as indicated by the darkly shaded gray regions with 4 vertexes around both objects 20 and 21.

In one embodiment, after the light transmitter L₄ is switched off, certain of the remaining light transmitters may be strategically selected to produce maximum information to further refine the area boundaries. The particular light transmitters selected can differ in different embodiments. For example, in the present illustrative embodiment, after switching on/off light transmitters L₀ and L₄, the next light transmitters that can be turned are light transmitters L₁ and L₁₃ for the area on the left of the touch screen 10 and light transmitters L₅ and L₈ for the area on the right of the touch screen 10.

In sum, the ‘optimized’ approach allows fewer transmitters to be switched on/off in each cycle as compared to the ‘plain’ scheme. One possible advantage of the present scheme is that results can be produced earlier and more efficiently than in the previously described schemes, resulting in a faster response and thus possible energy saving in comparison to the ‘Plain’ scheme.

C.—Interactive Switching Scheme

Another scheme for switching the light transmitters is referred to as the ‘interactive’ switching scheme. The interactive scheme utilizes a strategy for switching on light transmitters based on previous detection results. Specifically, knowing the position of an object (x, y) in a previous detection cycle (or sample time) allows the light switching scheme to be adapted to target that same area in subsequent detection cycles. To account for the rest of the screen area, a simple check could be performed to insure that there are no other new objects present. This scheme is based on the assumption that an object does not substantially change its position in a fraction of a second, from one detection cycle to the next, partly due to slow human reaction times as compared to the sample times of the hardware. One possible advantage of the interactive switching scheme is that results can be produced earlier and more efficiently than in the previously described schemes, resulting in a faster response and thus possible energy saving in comparison to the ‘Plain’ scheme.

The various switching schemes can be chosen to satisfy the specific requirements for a particular intended application. By way of example, two applications are listed in table IV, (i.e., interactive café table and chess game) each requiring a different switching scheme to account for the specific requirements of the particular application.

TABLE IV

| Characteristic | Interactive café table | Chess game |
|---|---|---|
| 1. Screen size | Large | Medium |
| 2. Screen shape | Oval | Rectangular |
| 3. Power consumption | Economy mode | High performance |
| 4. Modes | Idle | Intensive use |
| 5. Response time | Fast | Fast |
| 6. Means of interaction | Objects, coffee cups, hands | Chess pawns |

For example, for the Interactive café table application, it may be desirable to use the ‘optimized’ switching scheme, which uses less energy by virtue of obtaining detection results using fewer light transmitters. The ‘optimized’ switching scheme may also be applicable to both applications in that they both require fast response times (see characteristic 5).

According to another aspect of the invention, multiple light transmitters (e.g., two or more) can be switched on/off simultaneously. In this manner, more information can be received in less time, resulting in a faster response of the touch screen (i.e., a faster detection result).

Energy Saving or Idle Mode

According to yet another aspect of the invention, it is contemplated that if the touch screen 10 has not detected any changes for a certain period of time, the touch screen can switch into an energy saving mode thereby reducing processing power requirements and saving on total power consumption. In the idle or energy saving mode, the number of light transmitters and sensors used in each cycle are reduced while maintaining or reducing the cycle frequency (number of cycles per second). This results in a lower total ‘on time’ of the light transmitters per cycle, which results in a lower power consumption. Also if the number of lights being switched on and off per second is reduced, the required processing power of the system will be reduced as well. As soon as a number of changes are detected, the touch frame can switch back to a normal switching scheme.

Object Identification Based on an Object's Optical Properties

FIGS. 13-15 illustrate another aspect of the invention, which considers object identification based on an object's optical properties (i.e., light absorption, reflection and transmission). Specifically, in accordance with this aspect, the measurement of the light absorption of an object as well as the light reflection and transmission of the object is taken into account.

In an idealized case, the object being detected is assumed to absorb 100% of the impinging light from a light transmitter. In reality, depending on the optical properties of the material that an object is made of, the light that reaches the surface of the object is partly reflected, partly absorbed and partly transmitted by the object. The amount of light reflected, transmitted (i.e., pass through) and absorbed depends on the optical properties of the material of the object and is different for different materials. As a consequence, due to these physical phenomena, two objects of identical shape but made of different materials (e.g. glass and wood) can be distinguished if differences can be detected in the amount of light reflected, absorbed and transmitted by the objects.

A.—Partial Absorption and Partial Reflection Case

FIG. 13 illustrates a case where less than 100% of the light that reaches the object's surface gets absorbed by the object 33. That is, the light generated by the light transmitter L₀ is partly absorbed and partly reflected by the object 33. This leads to sensors S₀-S₄ on the touch screen 10 detecting some light that they would not detect otherwise (i.e. when there is no object present). It should be noted that the distribution of signal detected by sensors S₀-S₄ is not necessarily uniform, meaning that some sensors can detect slightly more light than others. The level of light detected by the sensors will depend on a number of factors like the distance between the object and a sensor, shape of the object, reflections caused by other objects, etc. It is also noted that sensors S₆ and S₇, by virtue of their being subjected to the shadow of the object, do not detect any signal.

B.—Total Absorption Case

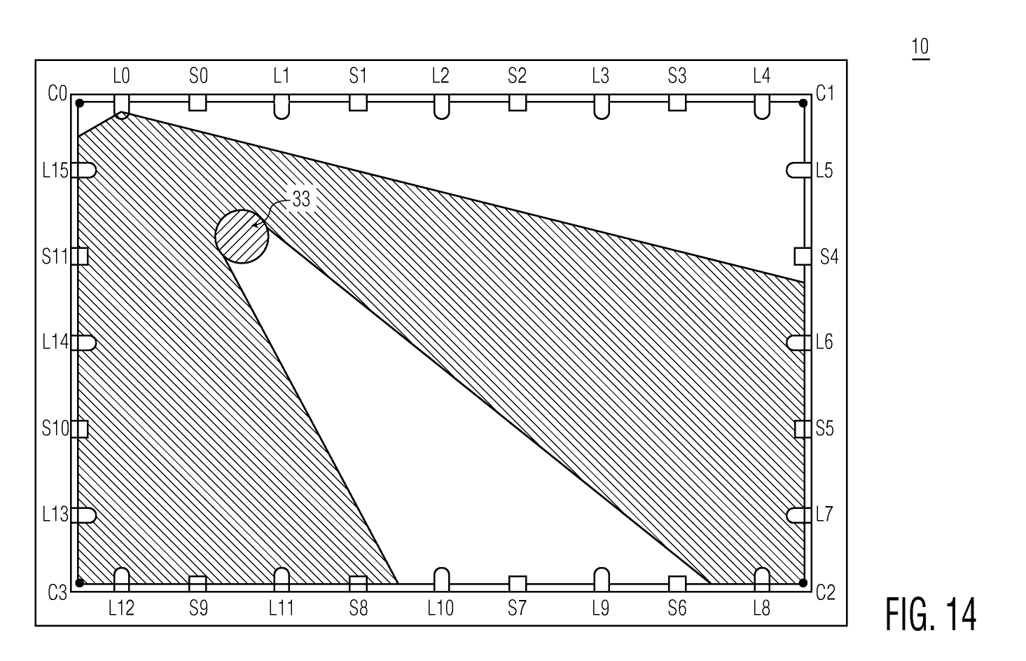

FIG. 14 illustrates a case where 100% of the light that reaches the object's surface gets absorbed by the object 33. As was true in the partial absorption case, sensors S₆ and S₇ do not detect any signal by virtue of their being subjected to the shadow of the object. However, this case differs from the partial absorption case in that sensors S₀-S₄ also do not detect any signal due to the total absorption of light by object 33. It should be noted that sensors (S₀-S₄) and (S₆-S₇) may detect some external noise generated by external light sources that would normally be negligible.

C.—Partial Absorption and Partial Transmission

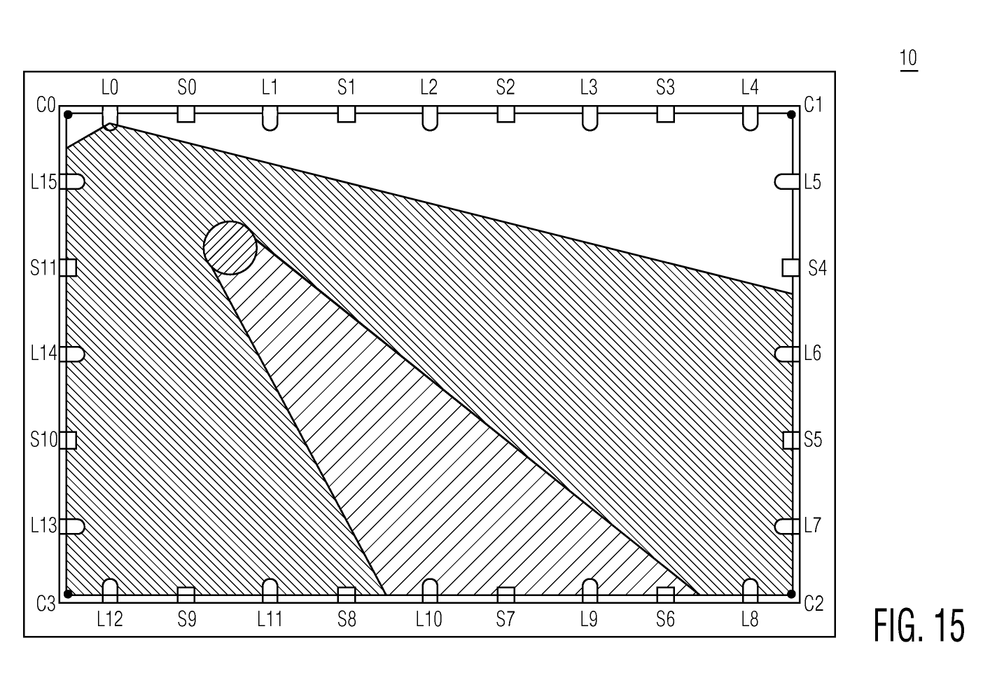

FIG. 15 illustrates a case where the light generated by the light transmitter L₀ is partly absorbed and partly transmitted by the object 33. This leads to sensors S6 and S7 detecting some light.

As described above and illustrated in FIGS. 13-15 above, objects of identical shape and size can still differ with regard to their optical characteristics. These differences will cause objects to absorb, reflect and transmit (i.e., pass through) different amounts of light emitted from a light transmitter.

It should be appreciated that according to an advantageous aspect, because the amount of light reflected and transmitted can be detected, as was shown in the examples above, objects of identical size and shape can be distinguished if they are made of materials with different optical properties.

D.—Detection of Optical Properties for Multiple Objects

According to another aspect of the invention, the simultaneous detection of optical properties of two or more objects is considered. In this case, two or more objects can have different shapes and sizes which would make the light distribution pattern detected by the sensors rather complex if it is desired to take into account the optical properties of the objects. To resolve these complexities, pattern recognition techniques could be applied to classify objects with respect to the optical properties such as reflectivity, absorption and transmissivity of the material they are made of.

Touch Screen Shapes and Configurations

FIG. 16 illustrates one embodiment where the touch screen 10 has an oval shape. Shapes other than a rectangular shape (e.g., circular) can be used as long as there are enough intersecting areas between the light transmitters and the sensors to meet the desired accuracy in location, shape and size detection. This is in contrast with prior art touch screen detection techniques which in most cases require a rectangular frame.

Variations in Sensor/Transmitter Density and Type

Because of the finite number of sensors in use and the fixed spacing there-between, the accuracy in determining the position, shape and size of an object is subject to uncertainty. In one embodiment, the uncertainty may be partially minimized by increasing the number of sensors used in the touch screen display 10. By increasing the number (density) of sensors, the relative spacing between the sensors decreases accordingly which leads to a more accurate calculation of the position, shape and size of an object.

In certain embodiments, the number of transmitters may be increased which also leads to a more accurate calculation of the position, shape and size of an object. It is noted that increasing the number of transmitters will highlight the object from additional angles thus providing additional information leading to more accurate results.

In certain embodiments, the overall measurement accuracy may be increased by increasing the density of transmitters and/or receivers in certain areas of the screen where detection proves to be less accurate than other areas. This non-even configuration of transmitters and/or receivers can compensate for the less accurate detection.

Overall measurement accuracy may suffer in certain situations dependent upon the position of the object on the touch screen. As such, differences in resolution and precision in detecting the location, shape and size of the object may occur. To explain these differences, three different situations are considered, (1) an object positioned in the center of the screen; (2) the same object positioned in the middle of the top edge of the screen (or any other edge); and (3) the same object positioned in the upper left corner of the screen (or any other corner of the screen).

FIG. 17 illustrates the first situation where a circular object 24 having diameter d is positioned in the center of the screen 10 and transmitter L₁₀ is switched on. This results in a shadow having length close to 2d on the opposite side of the screen 10. The shadow will be detected by the two sensors S₁ and S₂ provided that the distance between those two sensors is

|S2ₓ−S1ₓ|≦2d

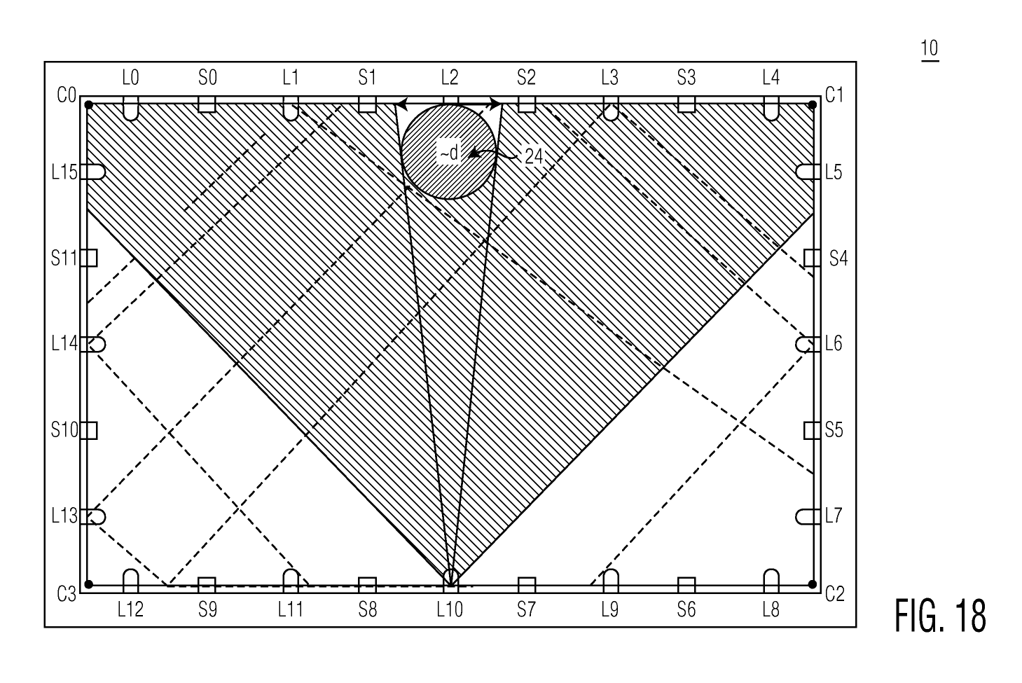

FIG. 18 illustrates the second situation where the same object 24 is placed close to the edge of the upper edge of the touch screen 10 and LED L₁₀ is switched on. As shown, a shadow is dropped by the object on the opposite side of the screen and is slightly longer than d, meaning that neither of the two sensors S1 and S2 will be able to detect any shadow. Comparing this situation with the first situation where the object 24 is in the center of the screen, in the current scenario the other transmitters L₀, L₁, L₃ and L₄ will not provide any information whereas in the first case (i.e., “object situated in the center”) the transmitters L₀, L₁, L₃ and L₄ would provide substantial information.

As can be seen in FIG. 18, the dashed lines indicate the light beams emitted by the corresponding transmitters (L₀, L₁, L₃, L₄). It can be noticed that the object in FIG. 18 is outside of the light beams and thus this object cannot be detected by those transmitters.

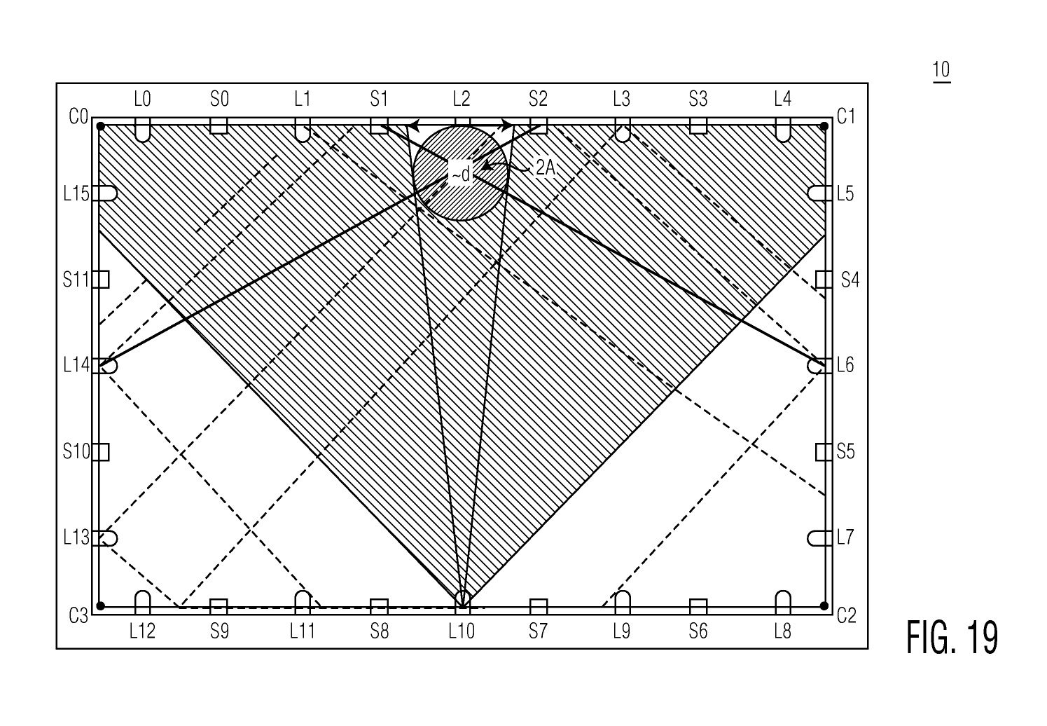

FIG. 19 illustrates that for the second situation, the only light transmitters that are capable of detecting the object are light transmitters L6 and L14.

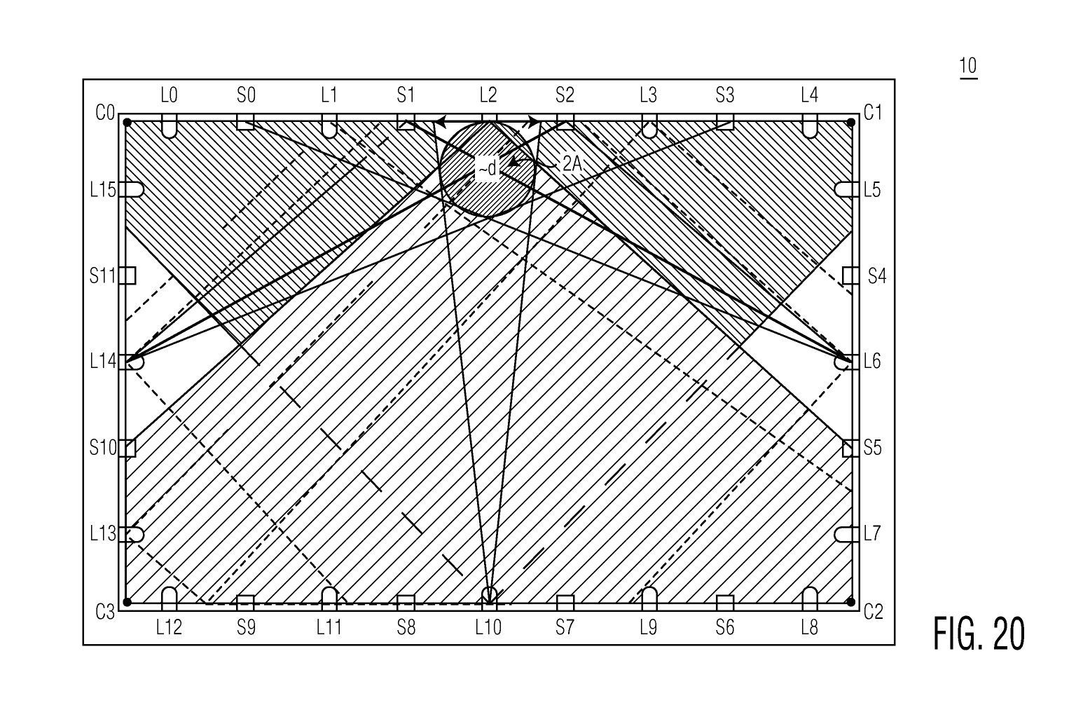

FIG. 20 illustrates that in the second situation (i.e., ‘close to the edge’) information is only provided by the light transmitters L₆, L₁₄ and L₂. That is, only the blocking of lines L₆-S₁, L₁₄-S₂ will be detected during the turn-on time of light transmitters L₆ and L₁₄. Further, none of the sensors S5-S10 will detect light during the turn-on time of light transmitter L₂. This will give us a rough indication of the position of the object as shown in FIG. 20 using the maximum area calculation method. However, it provides much less information about the object's size and form compared to the first situation described where the object is located “in the center”, as illustrated in FIG. 17.

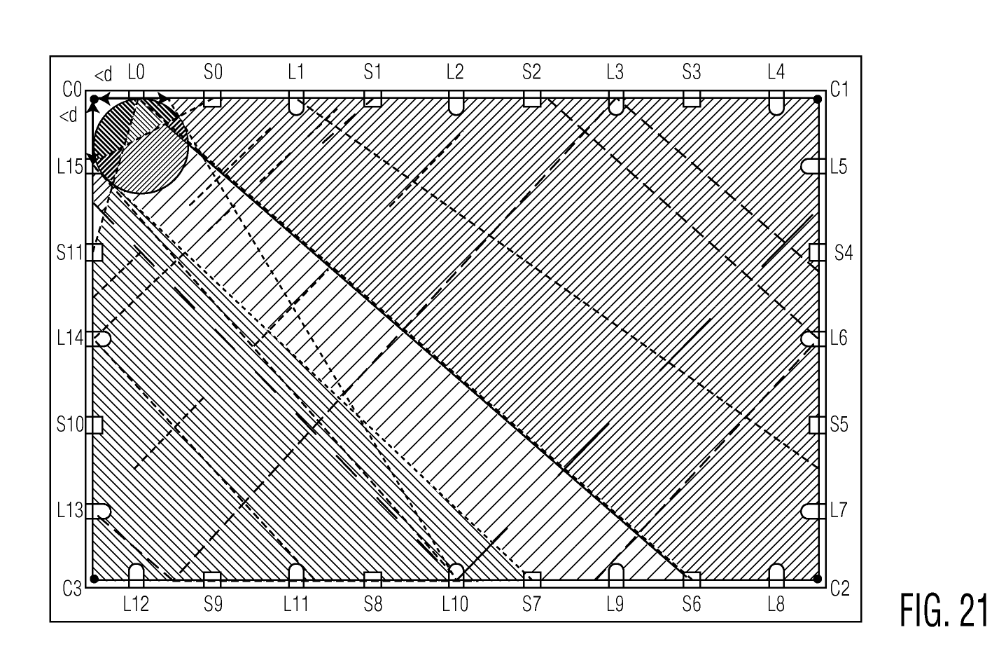

FIG. 21 illustrates an even more extreme situation (i.e., the third situation) where the same object 24 is now placed in the upper left corner of the touch screen 10. When the light transmitter L₁₀ is switched on during its turn-on time, it results in shadows along two edges of the corner both having the length <d. This shadow cannot be detected by any of the touch screen sensors. If we consider what can be detected in this situation by consequently switching on and off one LED after another, it become clear that only blocking of the L₀ and L₁₅ transmitters can be detected as shown in FIG. 21. The calculation of the maximum area in this case (intersection area marked with cellular pattern in FIG. 21) gives an even less precise estimation of the position, size and shape of the object compared to the two previous cases, ‘in the middle’ and ‘close to the edge’.

FIGS. 22-25 illustrate another embodiment where different angular positions are selected for the light transmitters. In other words, the light transmitters in certain embodiments can be oriented in a non-perpendicular orientation to the edge of the touch screen display 10.

Referring now to FIG. 22, the angle α indicates an angular measure between an edge of the screen and the axis of one of the light transmitters (e.g. L₀) and the angle β indicates an angular width of the emitted light beam from the light transmitter L₀.

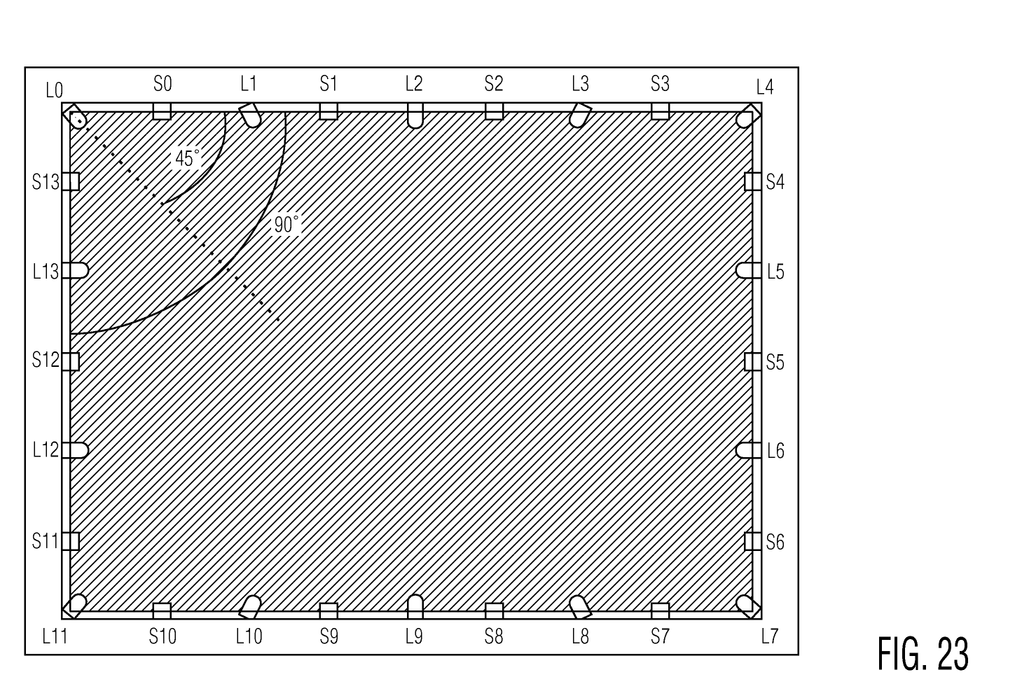

In FIG. 23, certain of the light transmitters are positioned in the corner areas of the touch screen display 10 and are rotated (angularly directed) towards the middle of the touch screen display, so that the light beam would light up the total screen area. It should be appreciated that by rotating the light transmitters in the corner areas, the efficiency of the rotated light transmitters is increased. It should also be noted that the angular rotations are fixed in the touch screen display 10 and cannot be re-oriented thereafter.

In a further embodiment of the present invention, a combination of different light transmitters may be used in the same application.

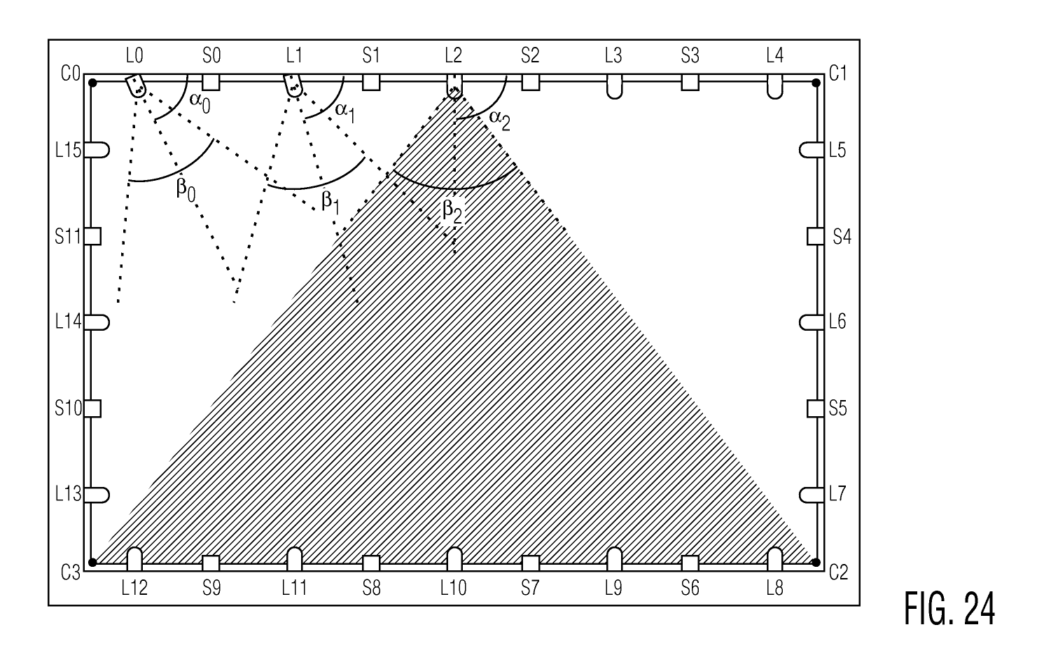

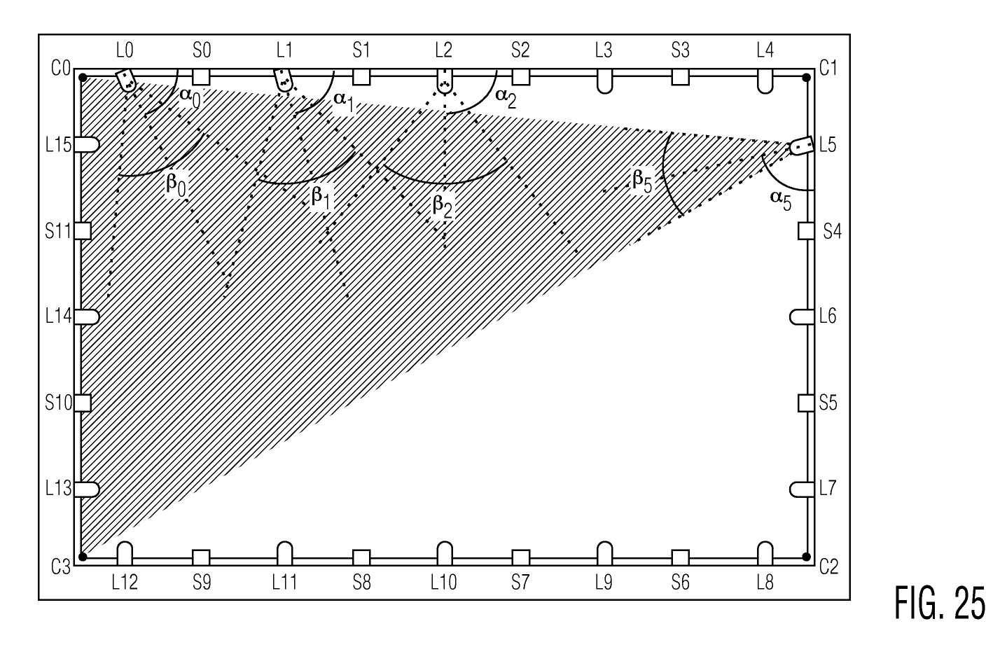

Referring again to FIGS. 24, 25 which illustrate transmitters having light beams of different angular widths. For example transmitters used in the corners of a rectangular screen would optimally have a 90-degree light beam since emitted light outside this angle will not be used. Other transmitters of the same touch screen however can emit a wider light beam.

### Applications

The invention has applicability to a broad range of applications, some of which will be discussed below. It should be appreciated, however, that the applications described below constitute a non-exhaustive list.
Electronic (Board) Games
To enable this type of application a large flat area, e.g. a table or a wall surface with a touch screen as input device could be used to display a game for one or more users. When a single user interacts with such application, the user can use more than one interaction point, (e.g. both hands) or the user can place tangible objects (e.g. pawns) on the surface. In such case the location of multiple touch points and multiple tangible objects can be detected and if necessary identified.
When more users play a game, they can play a game in their own private part of the touch screen without interaction with any of the other users at the same table, or they can participate together with other users in a single game. In both configurations the system can also participate in the game as one of the players.
Examples of games that can be played by single or multiple users with or without the system-opponent are logical games like chess or tic-tac-toe where positions of different pawns can be detected. The system can use this information to determine the next move, if it participates in the game, but it can also warn if a user makes an illegal move or provide help or suggestions based on the positions of the pawns.
Other examples are story telling games where tangible objects can be used by users to depict story situations. The system can detect, identify and track the objects to create an interactive story.
Electronic Drawing
This type of application can use the input of single of multiple users to make a drawing. One type of a drawing application can be finger-painting application for children where they can draw with their fingers or other objects like brushes on a large touch screen. Multiple children can draw at the same time, together or using their own private part of the screen.
Digital Writing and Drawing
When writing or drawing people usually rest the palm of their hand on the drawing surface to have an extra point of support. As a result to optimally support such tasks with electronic tablet PCs manufacturers have been looking for a method to differentiate between a hand and a stylus input. One solution was found to be a capacitive/inductive hybrid touch screen (ref: http://www.synaptics.com/support/507-003a.pdf). The method of the invention offers an alternative solution to this problem because it provides a capability for distinguishing between a hand and a stylus based on the shape and multiple touch points detected.
On Screen Keyboard
When inputting text with a virtual keyboard, input is usually restricted to a single key at a time. Key combinations with Shift, Ctrl and Alt keys are usually only possible through the use of ‘sticky’ keys. The touch screen as it is described in the current invention can detect multiple input points and thus detect key combinations which are common for physical keyboards
Gestures
Gestures can be a powerful way of interacting with systems. Nowadays most gestures come from a screen, tablets or other input devices with a single input point. This results in enabling only a limited set of gestures that are built up from (a sequential set) single lines or curves. The present invention also allows for gestures that consist of multiple lines and curves that are drawn simultaneously, or even enabling symbolic gestures by detecting the hand shape. This allows for more freedom in interaction styles, because more information can be conveyed to the system in a single user action.
An example gesture consisting of multiple input points is, e.g. two fingers closely placed together on a screen and moving them apart in two different directions. The example gesture can for instance be interpreted as ‘enlarge the window on screen to this new size relative to the starting point (of the gestures)’ in a desktop environment or ‘zoom in on this picture on the position of the starting point (of the gesture), with the zoom factor relative to the distance both fingers have traveled across the screen’ in a picture viewer application

The user interaction styles (techniques) enabled by the described touch screen include:
Input of a single touch point like in traditional touch screens
Input of multiple touch points, e.g. for
   input of distance with two touch points,
   input of sizes with two or more touch points,
   input of relations or links between displayed objects by simultaneously touching two or more objects
Input of convex hull shapes, e.g. for
   learning of and identification of learned shapes,
   identification of standard shapes like circle, triangle, square, rectangle, etc.
Input of optical parameters (transparency, reflectivity, transmissivity) of objects or materials, e.g. for
   learning of and identification of learned objects or materials
   identification of standard objects, e.g. plastic pawns or chess pieces, or materials, e.g. glass, plastic, wood
Tracking of one or multiple objects, e.g. for
   learning and recognizing gestures
   recognizing standard gestures

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for detecting the location, shape and size of at least one object placed on a plane within the touch sensor boundaries of a touch screen (10), the touch screen (10) including on its periphery a plurality of light transmitters Lᵢ{i=1−N} and a plurality of sensors Sₖ{k=1−M}, the method comprising the acts of:
(a) acquiring calibration data for each of the N light transmitters Lᵢ;
(b) acquiring non-calibration data for each of the N light transmitters Lᵢ;
(c) computing N minimum area estimates of said at least one object using the calibration data and the non-calibration data;
(d) combining the N minimum area estimates to derive a total minimum object area estimate of the at least one object;
(e) computing N maximum area estimates of said at least one object using the calibration data and the non-calibration data;
(f) combining the N maximum area estimates to derive a total maximum object area estimate of the at least one object; and
(g) combining the total minimum and maximum object area estimates to derive the boundary area of the at least one object.

2. The method of claim 1, wherein said act (a) of acquiring calibration data is performed over a single cycle of operation starting with a first light transmitter Lᵢ (i=1) and ending with a last light transmitter Lᵢ (i=N).

3. The method of claim 2, wherein said act (a) of acquiring calibration data further comprises the acts of:
turning on each of said N light transmitters Lᵢ for a predetermined length of time in a predetermined sequence;
during the turn-on time of said i-th light transmitter Lᵢ, detecting the presence or absence of a light signal from said i-th light transmitter Lᵢ at each of said M sensors Sₖ; and
storing the detected presence or absence of said light signal from said i-th light transmitter for each of said M sensors Sₖ as said calibration data.

4. The method of claim 2, wherein said act (a) of acquiring calibration data is performed with no objects present in the plane of the touch screen (10).

5. The method of claim 1, wherein said acts (b) through (g) are performed over multiple sequential cycles of operation.

6. The method of claim 1, wherein said act (b) further comprises the acts of:
(a) turning on each of said N light transmitters Lᵢ in a predetermined sequence for a predetermined length of time; and
(b) during the turn-on time of said ith light transmitter Lᵢ, detecting the presence or absence of a light signal from said i-th light transmitter Lᵢ at each of said M sensors Sₖ; and
(c) storing the presence or absence of said light signal from said i-th light transmitter for each of said M sensors Sₖ as said non-calibration data.

7. The method of claim 6, wherein said act (b) of acquiring non-calibration data is performed in the presence of said at least one object.

8. The method of claim 1, wherein said act (c) further comprises:
(1) retrieving the calibration data from a data repository;
(2) retrieving the non-calibration data from the data repository;
(3) determining from the retrieved calibration data a range of sensors M illuminated by the i-th light transmitter;
(4) determining from the retrieved non-calibration data a range of sensors M not illuminated by the i-th light transmitter;
(5) computing an i-th minimum area estimate for the at least one object from the range of sensors M illuminated by the i-th light transmitter determined at said act (3) and from the range of sensors M illuminated by the i-th light transmitter determined at said act (4); and
(6) repeating said acts (3)-(5) for each light transmitter Lᵢ.

9. The method of claim 8, further comprising the act of storing the N minimum area estimates.

10. The method of claim 1, wherein said act (d) further comprises the act of performing a mathematical intersection of the N minimum area estimates computed at said act (c).

11. The method of claim 10, wherein the mathematical intersection of the N minimum area estimates is computed as:
$${A}_{{Total}_{min}} = \{ \begin{matrix}∅ , & if {A}_{{L}_{{0}_{min}}} = {A}_{{L}_{{1}_{min}}} = … = {A}_{{L}_{{N}_{min}}} = 0 \\ ( {{⋂}^{N - 1}}_{i = 0 , {A}_{{L}_{i max}}} {A}_{{L}_{i max}} ) , & otherwise\end{matrix} \qquad ( 2 )$$

12. The method of claim 8, further comprising the act of storing the N maximum area estimates.

13. The method of claim 1, wherein said act (e) further comprises the act of performing a mathematical intersection of the N maximum area estimates computed at said act (e).

14. The method of claim 13, wherein the mathematical intersection of the N maximum area estimates is computed as:
$${A}_{{Total}_{max}} = \{ \begin{matrix}∅ , & if {A}_{{L}_{{0}_{max}}} = {A}_{{L}_{{1}_{max}}} = … = {A}_{{L}_{{N}_{max}}} = 0 \\ {{⋂}^{N - 1} {A}_{{L}_{{i}_{max}}} ,}_{i = 0 , {A}_{{L}_{{i}_{max}}} \neq ∅} & otherwise\end{matrix} \qquad ( 1 )$$

15. The method of claim 1, wherein said act (g) further comprises the act of performing a mathematical intersection of the total minimum object area estimate derived at said act (d) and the total maximum object area estimate derived at said act (f).

16. The method of claim 6, wherein said predetermined sequence is one of a (a) plain sequence, (b) optimized sequence and (c) interactive sequence.

17. The method of claim 16, wherein turning on each of said N light transmitters Lᵢ in accordance with the plain sequence comprises the acts of:
i) turning on a first light transmitter Lᵢ located in the periphery of the touch screen (10) for said predetermined length of time;
ii) proceeding in one of a clockwise or counter-clockwise direction to an adjacent light transmitter Lᵢ located in the periphery of the touch screen (10);
iii) turning on said adjacent light transmitter Lᵢ located in the periphery of the touch screen (10) for said predetermined length of time;
iv) repeating said acts (ii)-(iii) for each light transmitter Lᵢ located in the periphery of the touch screen (10).

18. The method of claim 16, wherein turning on each of said N light transmitters Lᵢ in accordance with the optimized sequence comprises the acts of:
i) sequentially turning on those light transmitter Lᵢ located in the respective corners of the periphery of the touch screen (10) for a predetermined length of time and
ii) selecting at least one additional light transmitter Lᵢ located in on the periphery of the touch screen (10) to provide maximum detection information; and
ii) turning on the selected at least one additional light transmitter Lᵢ touch screen (10).

19. The method of claim 16, wherein turning on each of said N light transmitters Lᵢ in accordance with the interactive sequence comprises:
i) retrieving non-calibration data from a previous cycle of operation;
ii) determining from the non-calibration data in a present cycle of operation which of said light transmitters Lᵢ to turn on, where the determination is a based on the at least one object's previously detected position
iii) turning on said light transmitters Lᵢ as determined at act (ii) in a further predetermined sequence for said predetermined length of time;
iv) turning on each of the respective corner light transmitters Lᵢ touch screen (10).

20. An apparatus for detecting the location, shape and size of at least one object placed on a plane within the touch sensor boundaries of a touch screen (10), the touch screen (10) comprising a plurality of light transmitters Lᵢ {i=1−N} and sensors Sₖ {k=1−M} arranged around a periphery of said touch screen (10).

21. An apparatus according to claim 20, wherein the plurality of light transmitters Lᵢ {i=1−N} and the plurality of sensors Sₖ {k=1−M} are arranged in an alternating pattern around the periphery of the touch screen (10).

22. An apparatus according to claim 20, wherein the shape of said touch screen (10) is one of a square, a circle and an oval.

23. An apparatus according to claim 20, wherein each transmitter Lᵢ transmits a light beam having a characteristic light beam width \acute{α} during its respective turn-on time.

24. The apparatus of claim 23, wherein the characteristic light beam width \acute{α} can be different for different light transmitters.

25. An apparatus according to claim 20, wherein said plurality of light transmitters Lᵢ {i=1−N} is located in a first plane around the periphery of the touch screen (10) and the plurality of sensors Sₖ {k=1−M} are arranged in a second plane around the periphery of the touch screen (10), wherein said second plane is substantially adjacent said first plane.

26. An apparatus according to claim 20, wherein each of said light transmitters Lᵢ are spaced equidistant around the periphery of said touch screen (10).

27. An apparatus according to claim 21, wherein each of said light transmitters Lᵢ are spaced non-equidistant around the periphery of said touch screen (10).

28. An apparatus according to claim 21, wherein certain of said light transmitters Lᵢ orientation towards the center of said touch screen (10) is not perpendicular to said touch screen (10).

29. An apparatus for detecting the location, shape and size of at least one object placed on a plane within the touch sensor boundaries of a touch screen (10), the touch screen (10) including on its periphery a plurality of light transmitters Lᵢ {i=1−N} and a plurality of sensors Sₖ {k=1−M}, the system comprising:
means for acquiring calibration data for each of the N light transmitters Lᵢ;
means for acquiring non-calibration data for each of the N light transmitters Lᵢ;
means for computing N minimum area estimates of said at least one object using the calibration data and the non-calibration data;
means for combining the N minimum area estimates to derive a total minimum object area of the at least one object;
means for computing N maximum area estimates of said at least one object using the calibration data and the non-calibration data;
means for combining the N maximum area estimates to derive a total maximum object area of the at least one object; and
means for combining the total minimum and maximum object areas to derive an actual object area of the at least one object.
